(19) United States
(12) Patent Application Publication
(10) Pub. No.: US 2007/0124180 A1
(43) Pub. Date: May 31, 2007

(54) Information processing system

(76) Inventor: Eiji Takeuchi, Osaka (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/563,376

(22) PCT Filed: Dec. 21, 2004
(86) PCT No.: PCT/JP04/19079

§ 371 Date: Oct. 6, 2006

(51) Int. Cl. G06Q 10/00

(52) U.S. Cl. 705/5

(57) ABSTRACT

There has been a problem in that it is necessary to separately access the sites of hotels, airlines and the like to arrange reservations, resulting in complicated operations. There are provided a user information receiving portion 133 that receives traveler information, which is information relating to a traveler, and travel duration information, which is information relating travel duration, a first information acquisition portion 134 that acquires first travel service information, which is information relating to reservation for a first travel service, from a first travel service server device 110 based on the traveler information and the travel duration information, and a second information acquisition portion 135 that acquires second travel service information, which is information relating to reservation for a second travel service, from second travel service server device 120 based on the traveler information and the travel duration information.

### TECHNICAL FIELD

The present invention relates to an information processing system and the like for arranging reservations for services relating to travel.

### BACKGROUND ART

Recently, it is becoming common for hotels, airlines and the like to use, for example, web sites (hereinafter, abbreviated as “sites”) that they operate to provide information on the content of the services that they provide. At the same time, it is often the case that the same site accepts inquiries for room availability or reservations for accommodation in the case of a hotel, or inquiries for seat availability or reservations for airline tickets in the case of an airline (for example, JP2002-175455A (e.g., page 1 and FIG. 1)).

By using such a site, when the services provided by a hotel, an airline and the like suit the user's interest after the user has viewed the detailed information provided on a site, the user can directly make an inquiry regarding the reservation status or make a reservation for a hotel or an airline ticket on that site.

However, a user who has plans to travel needs to separately access the sites of a hotel, an airline and the like to arrange a reservation for a room, an airline ticket and the like. For this reason, there has been a problem in that such arrangement for reservation is very complicated for the user.

On the other hand, in order to save labor for such arrangement, the user may in some cases, for example, make a request to a hotel to provide other travel-related services, such as arranging a restaurant reservation or an airline reservation, when making a reservation at the hotel. Since such arrangement for reservation is favorable to the hotel from the viewpoint of providing improved service, the hotel will arrange reservation and the like for the service requested by the user. However, there has been a problem in that such an operation is often actually very troublesome to the hotel, and may in some cases hinder other operations. In addition, there is a problem in that if the number of users who make such a request increases, it is necessary to hire personnel for performing such an operation, such as a concierge, resulting in very high costs.

### DISCLOSURE OF INVENTION

An information processing system according to the present invention is an information processing system including a first travel service server device, a second travel service server device, a travel service arrangement server device and an information terminal, the first travel service server device including: a first page storing portion that stores a first travel service page, which is a web page relating to the first travel service and including a link to a travel service arrangement page; a first information storing portion that stores first travel service information, which is information relating to reservation for the first travel service; a first request receiving portion that receives a first travel service page transmission request, which is a request to transmit the first travel service page, from the information terminal; and a first page transmitting portion that transmits the first travel service page to the information terminal if the page transmission request has been received, the second travel service server device including: a second information storing portion that stores second travel service information, which is information relating to reservation for the second travel service, the travel service arrangement server device including: an arrangement page storing portion that stores the travel service arrangement page, which is a web page relating to arrangement for reservation for the first and second travel services; an arrangement page transmitting portion that transmits, to the information terminal, the travel service arrangement page, to which the first travel service page jumps, in response to a jump instruction from the information terminal; a user information receiving portion that receives traveler information, which is information relating to a traveler, and travel duration information, which is information relating to travel duration; a first information acquisition portion that acquires the first travel service information in the first travel service server device based on the traveler information and the travel duration information; a second information acquisition portion that acquires the second travel service information in the second travel service server device based on the traveler information and the travel duration information; and an acquired information transmitting portion that transmits the first travel service information acquired by the first information acquisition portion and the second travel service information acquired by the second information acquisition portion, the information terminal including: an input receiving portion that receives input of the first travel service page transmission request, a jump instruction and user information including the traveler information and the travel duration information; an information transmitting portion that transmits the first travel service page transmission request to the first travel service server device, transmits the jump instruction to the travel service arrangement server device, and transmits the user information to the travel service arrangement server device; an information receiving portion that receives the first travel service page from the first travel service server device, and receives the travel service arrangement page, the first travel service information and the second travel service information from the travel service arrangement server device; and an information output portion that outputs the first travel service page, the travel service arrangement page, the first travel service information and the second travel service information that have been received by the information receiving portion.

With such a configuration, it is not necessary to separately arrange reservation for the first travel service and that for the second travel service, making it possible to improve the convenience in arranging reservations. Furthermore, the information on the user side is converted into the information on the side of the providers of the first and second travel services, and this is used to acquire the first travel service information and the second travel service information. Accordingly, the user can acquire appropriate reservation information even if the user does not know the information on the side of the providers of the first and second travel services, thus making it possible to improve the convenience in arranging reservations. Further, during arranging reservations, the information determined by using the first travel service can be incorporated into the information necessary for making a reservation for the second travel service. Accordingly, it is not necessary for the user to input this information, making it possible to improve the convenience in arranging reservations.

Furthermore, in the above-described information processing system, the first travel service is a service providing an accommodation, the first information storing portion of the first travel service server device stores accommodation information relating to reservation for the accommodation as the first travel service information, and the first information acquisition portion includes: a room type deciding means that decides a room type of the accommodation based on the traveler information; and an accommodation information acquisition means that acquires the accommodation information from the first travel service server device, using the travel duration information and the room type as keys.

With such a configuration, the information on the user side is converted into the information on the side of the providers of the first and second travel services, and this is used to acquire the first travel service information and the second travel service information. Accordingly, the user can acquire appropriate reservation information even if the user does not know the information on the side of the providers of the first and second travel services, thus making it possible to improve the convenience in arranging reservations.

Furthermore, in the above-described information processing system, the second travel service is a service providing an accommodation, the second information storing portion of the second travel service server device stores accommodation information relating to reservation for the accommodation as the second travel service information, and the second information acquisition portion includes: a room type deciding means that decides a room type of the accommodation based on the traveler information; and an accommodation information acquisition means that acquires the accommodation information from the second travel service server device, using the travel duration information and the room type as keys.

With such a configuration, the information on the user side is converted into the information on the side of the providers of the first and second travel services, and this is used to acquire the first travel service information and the second travel service information. Accordingly, the user can acquire appropriate reservation information even if the user does not know the information on the side of the providers of the first and second travel services, thus making it possible to improve the convenience in arranging reservations.

Furthermore, in the above-described information processing system, the first travel service is a passenger transport service, the first information storing portion of the first travel service server device stores, as the first travel service information, passenger transport reservation information relating to reservation for the passenger transport service, and the first information acquisition portion includes: a seat count deciding means that decides a seat count based on age information indicating the age of the traveler that is included in the traveler information; a date deciding means that decides a departure date and/or return date from the travel duration information; and a passenger transport reservation information acquisition means that acquires the passenger transport reservation information from the first travel service server device, using the seat count, and the departure date and/or return date as keys.

With such a configuration, the information on the user side is converted into the information on the side of the providers of the first and second travel services, and this is used to acquire the first travel service information and the second travel service information. Accordingly, the user can acquire appropriate reservation information even if the user does not know the information on the side of the providers of the first and second travel services, thus making it possible to improve the convenience in arranging reservations.

Furthermore, in the above-described information processing system, the second travel service is a passenger transport service, the second information storing portion of the second travel service server device stores, as the second travel service information, passenger transport reservation information relating to reservation for the passenger transport service, and the second information acquisition portion includes: a seat count deciding means that decides a seat count based on age information indicating the age of the traveler that is included in the traveler information; a date deciding means that decides a departure date and/or return date from the travel duration information; and a passenger transport reservation information acquisition means that acquires the passenger transport reservation information from the second travel service server device, using the seat count, and the departure date and/or return date as keys.

With such a configuration, the information on the user side is converted into the information on the side of the providers of the first and second travel services, and this is used to acquire the first travel service information and the second travel service information. Accordingly, the user can acquire appropriate reservation information even if the user does not know the information on the side of the providers of the first and second travel services, thus making it possible to improve the convenience in arranging reservations.

Furthermore, in the above-described information processing system, the first travel service is a service providing a rental car, the first information storing portion of the first travel service server device stores rental car information relating to reservation for the rental car as the first travel service information, and the first information acquisition portion includes: a car type deciding means that decides a car type to be reserved, based on the traveler information; a period deciding means that decides a period for which the rental car is to be rented, based on the travel duration information; and a rental car reservation information acquisition means that acquires the rental car information from the first travel service server device, using the car type and the period for which the rental car is to be rented as keys.

With such a configuration, the information on the user side is converted into the information on the side of the providers of the first and second travel services, and this is used to acquire the first travel service information and the second travel service information. Accordingly, the user can acquire appropriate reservation information even if the user does not know the information on the side of the providers of the first and second travel services, thus making it possible to improve the convenience in arranging reservations.

Furthermore, in the above-described information processing system, the second travel service is a service providing a rental car, the second information storing portion of the second travel service server device stores rental car information relating to reservation for the rental car as the second travel service information, and the second information acquisition portion includes: a car type deciding means that decides a car type to be reserved, based on the traveler information; a period deciding means that decides a period for which the rental car is to be rented, based on the travel duration information; and a rental car reservation information acquisition means that acquires the rental car information from the second travel service server device, using the car type and the period for which the rental car is to be rented as keys.

With such a configuration, the information on the user side is converted into the information on the side of the providers of the first and second travel services, and this is used to acquire the first travel service information and the second travel service information. Accordingly, the user can acquire appropriate reservation information even if the user does not know the information on the side of the providers of the first and second travel services, thus making it possible to improve the convenience in arranging reservations.

Furthermore, in the above-described information processing system, the traveler information includes age information relating to the age of the traveler, and the second information acquisition portion includes a child seat deciding means that decides the necessity or not of reserving a child seat, based on the age information.

With such a configuration, the information on the user side is converted into the information on the side of the providers of the first and second travel services, and this is used to acquire the first travel service information and the second travel service information. Accordingly, the user can acquire appropriate reservation information even if the user does not know the information on the side of the providers of the first and second travel services, thus making it possible to improve the convenience in arranging reservations.

Furthermore, in the above-described information processing system, the first travel service is a service providing an activity, the first information storing portion of the first travel service server device stores activity reservation information relating to reservation for the activity as the first travel service information, and the first information acquisition portion acquires the activity reservation information from the first travel service server device, based on the traveler information and the travel duration information.

The information on the user side is converted into the information on the side of the providers of the first and second travel services, and this is used to acquire the first travel service information and the second travel service information. Accordingly, the user can acquire appropriate reservation information even if the user does not know the information on the side of the providers of the first and second travel services, thus making it possible to improve the convenience in arranging reservations.

Furthermore, in the above-described information processing system, the second travel service is a service providing an activity, the second information storing portion of the second travel service server device stores activity reservation information relating to reservation for the activity as the second travel service information, and the second information acquisition portion acquires the activity reservation information from the second travel service server device, based on the traveler information and the travel duration information.

With such a configuration, the information on the user side is converted into the information on the side of the providers of the first and second travel services, and this is used to acquire the first travel service information and the second travel service information. Accordingly, the user can acquire appropriate reservation information even if the user does not know the information on the side of the providers of the first and second travel services, thus making it possible to improve the convenience in arranging reservations.

Furthermore, in the above-described information processing system, the information acquired by the first information acquisition portion or the second information acquisition portion varies depending on the information in the first travel service server device that is included in the jump instruction from the information terminal.

With such a configuration, it is possible to perform reservation suitable for the first travel service server device.

Furthermore, the above-described information processing system further includes: a region deciding portion that decides a travel destination region based on the information in the first travel service server device that is included in the jump instruction from the information terminal, wherein the information acquired by the first information acquisition portion or the second information acquisition portion varies depending on the region.

With such a configuration, it is possible to readily perform reservation suitable for a travel destination region.

Furthermore, in the above-described information processing system, it is judged whether a region relating to the first travel service server device and a region relating to the second travel service server device are the same region, and the information acquired by the first information acquisition portion or the second information acquisition portion differs between when the regions are the same and when the regions are not the same.

With such a configuration, it is possible to readily perform reservation suitable for a travel destination region.

Furthermore, the above-described information processing system further includes: a region information acquisition portion that acquires, based on the region, information unique to the region, wherein the acquired information transmitting portion also transmits the information unique to the region.

With such a configuration, it is possible to receive information on a travel destination that should be known in advance, making it possible to save the time and trouble for searching for the necessary information about the travel destination.

Furthermore, a travel service arrangement server device according to the present invention is a travel service arrangement server device including: a user information receiving portion that receives traveler information, which is information relating to a traveler, and travel duration information, which is information relating to travel duration; a first information acquisition portion that acquires first travel service information, which is information relating to reservation for a first travel service, based on the traveler information and the travel duration information; a second information acquisition portion that acquires second travel service information, which is information relating to reservation for a second travel service, base on the traveler information and the travel duration information; and an acquired information transmitting portion that transmits the first travel service information acquired by the first information acquisition portion and second travel service information acquired by the second information acquisition portion.

With such a configuration, the information on the user side is converted into the information on the side of the providers of the first and second travel services, and this is used to acquire the first travel service information and the second travel service information. Accordingly, the user can acquire appropriate reservation information even if the user does not know the information on the side of the providers of the first and second travel services, thus making it possible to improve the convenience in arranging reservations.

With the information processing system according to the present invention, the user can easily arrange the reservations necessary for travel.

### BRIEF DESCRIPTION OF DRAWINGS

FIG. 1 is a schematic diagram of an information processing system according to Embodiment 1 of the present invention.

FIG. 2 is a block diagram of the information processing system.

FIG. 3 is a flowchart for illustrating the operation of the information processing system.

FIG. 4 is a flowchart for illustrating the operation of the information processing system.

FIG. 5 is a flowchart for illustrating the operation of the information processing system.

FIG. 6 is a flowchart for illustrating the operation of the information processing system.

FIG. 7 is a flowchart for illustrating the operation of the information processing system.

FIG. 8 is a flowchart for illustrating the operation of the information processing system.

FIG. 9 is a diagram showing an exemplary display of the information processing system.

FIG. 10 is a diagram showing an exemplary display of the information processing system.

FIG. 11 is a diagram showing an exemplary data structure of the information processing system.

FIG. 12 is diagram showing an exemplary data structure of the information processing system.

FIG. 13 is a diagram showing an exemplary display of the information processing system.

FIG. 14 is a block diagram of an information processing system according to Embodiment 2 of the present invention.

FIG. 15 is a flowchart for illustrating the operation of the information processing system.

FIG. 16 is a flowchart for illustrating the operation of the information processing system.

FIG. 17 is a diagram showing an exemplary display of the information processing system.

FIG. 18 is a diagram showing an exemplary data structure of the information processing system.

FIG. 19 is a diagram showing an exemplary data structure of the information processing system.

FIG. 20 is a block diagram showing a modified example of the information processing system.

FIG. 21 is a block diagram showing a modified example of the information processing system.

### BEST MODE FOR CARRYING OUT THE INVENTION

Hereinafter, embodiments of an information processing system and the like will be described with reference to the accompanying drawings. It should be noted that structural components denoted by the same reference numerals in the embodiments perform the same operation, and therefore may not be described in duplicate.

### Embodiment 1

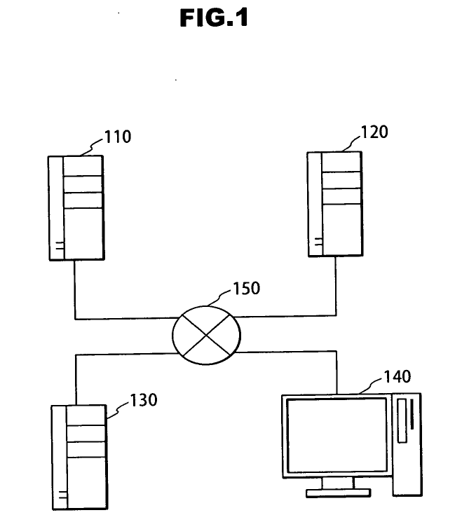

FIG. 1 is a schematic diagram of an information processing system according to Embodiment 1 of the present invention. The information processing system of Embodiment 1 of the present invention is provided with a first travel service server device 110, a second travel service server device 120, a travel service arrangement server device 130 and an information terminal 140. The first travel service server device 110, the second travel service server device 120, the travel service arrangement server device 130 and the information terminal 140 are connected to each other via a network 150.

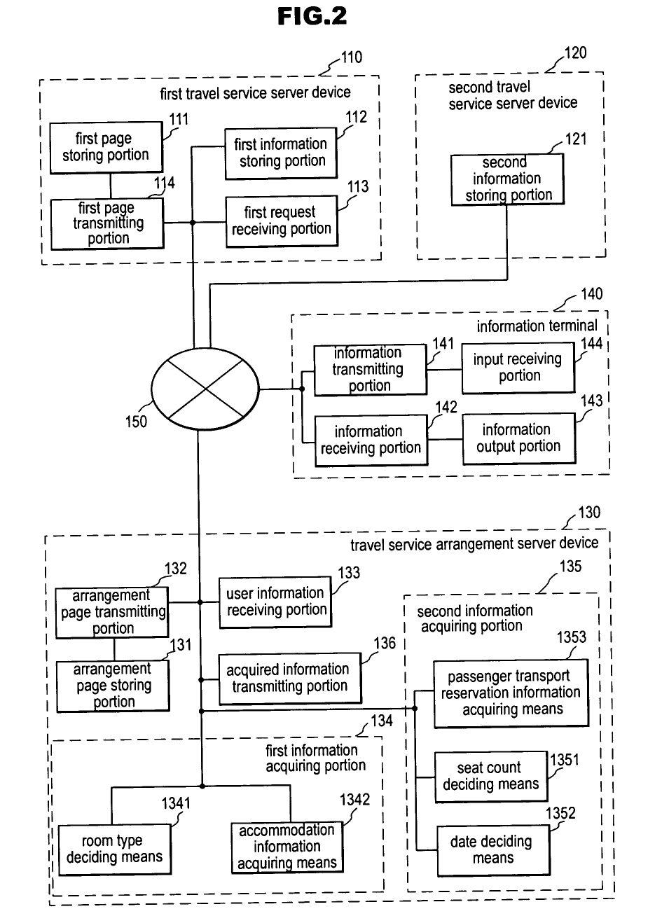

FIG. 2 is a block diagram of the information processing system according to Embodiment 1 of the present invention. The information processing system of Embodiment 1 of the present invention is provided with a first travel service server device 110, a second travel service server device 120, a travel service arrangement server device 130 and an information terminal 140. The first travel service server device 110, the second travel service server device 120, the travel service arrangement server device 130 and the information terminal 140 are connected to each other via a network 150.

The first travel service server device 110 includes a first page storing portion 111, a first information storing portion 112, a first request receiving portion 113 and a first page transmitting portion 114.

The second travel service server device 120 includes a second information storing portion 121.

The travel service arrangement server device 130 includes an arrangement page storing portion 131, an arrangement page transmitting portion 132, a user information receiving portion 133, a first information acquisition portion 134, a second information acquisition portion 135 and an acquired information transmitting portion 136.

The first information acquisition portion 134 includes a room type deciding means 1341 and an accommodation information acquisition means 1342.

The second information acquisition portion 135 includes a seat count deciding means 1351, a date deciding means 1352 and a passenger transport reservation information acquisition means 1353.

The information terminal 140 includes an information transmitting portion 141, an information receiving portion 142, an information output portion 143 and an input receiving portion 144. The information terminal 140 may be, for example, a PC, a mobile phone, a PDA, or a television set capable of transmitting and receiving data.

The first page storing portion 111 stores a first travel service page, which is a web page relating to a first travel service. The first travel service page includes a link to a travel service arrangement page, which will be described later. “Travel service” refers to services relating to travel, including, for example, a service providing accommodations such as a hotel, a Japanese-style inn and a rental villa, a passenger transport service with an airplane, a train, a ship or the like, a service providing rental cars, and a service providing activities, such as making a reservation for use of a diving site, a golf course and the like, a reservation for a ticket for a concert, a theater, a sports event and the like, and a reservation for eating places such as a restaurant. “Activity” refers to activities at a travel destination. The activity includes what is usually called an “optional tour” in Japan. In this embodiment, a service providing accommodations will be described as an example of the first travel service. Specifically, the first travel service page is a web page that displays the content and the like of the first travel service with text and images. For example, it is a web page that introduces the facilities of accommodations with photographs, and allows, for example, reservation for accommodations via the screen. “Web page” refers to a page that can be browsed via a network such as the Internet, and stored, for example, as data described in HTML, XML or the like. Its data format and the like may be of any type, as long as the web page can be output from the information terminal 140 using a browser or the like. “Link” refers to information for displaying a destination web page, and includes information indicating, for example, the location where the data of the destination web page is stored, or the location where the program or the like for dynamically creating the destination web page is stored. The first page storing portion 111 can be implemented, for example, with a nonvolatile recording medium or a volatile recording medium. Examples of the nonvolatile recording medium include a hard disk and a non-rewritable optical disk.

The first information storing portion 112 stores first travel service information, which is information relating to reservation for the first travel service. The first travel service information (hereinafter, referred to as “first information”) is stored, for example, as several separate data items so that it can be retrieved using a search key or the like. The first information may be, for example, information that indicates, for example, the state of whether reservation for the first travel service is possible. For example, when the first travel service is a passenger transport service using an airplane, the first information may be information indicating the seat availability of the airplane, information indicating a boarding date, or the like. Here, since the first travel service is described as a service providing accommodations, the first information is accommodation information relating to reservation for the accommodations. The accommodation information may be information indicating, for example, the room availability, the rates of available rooms and the like of the accommodations. The first information storing portion 112 can be implemented, for example, with a nonvolatile recording medium or a volatile recording medium. Examples of the nonvolatile recording medium include a hard disk and a non-rewritable optical disk.

In this embodiment, although not shown, the first travel service server device 110 includes a first information acquisition portion by way of example. This acquisition portion receives a request from the outside to transmit the first information, then acquires the first information specified by that transmission request from the first information storing portion 112, and transmits the acquired first information to a device that is the sender of the transmission request. Such an acquisition portion may be implemented, for example, with an MPU or a memory, and a wired or wireless communications means such as a modem or a network card, or a wired or wireless broadcasting means. However, these processes may also be performed, for example, by the first request receiving portion 113 or the first page transmitting portion 114.

The first request receiving portion 113 receives a first travel service page transmission request, which is a request to transmit the first travel service page, from the information terminal 140. The first travel service page transmission request includes, for example, a URL as information specifying the first travel service page. The information specifying the first travel service page may be any information indicating the location where the first travel service page is present, such as a URI, a folder name with a file name, or an IP address with a file name. The first request receiving portion 113 may receive the first travel service page transmission request from the information terminal 140, for example, via a wired or wireless communications line, or wired or wireless broadcasting. The first request receiving portion 113 may be constituted, for example, by a wired or wireless communications means such as a modem or a network card, or a wired or wireless broadcasting means.

When the first request receiving portion 113 has received the first travel service page transmission request, the first page transmitting portion 114 transmits the first travel service page to the above-described information terminal. Specifically, based on the first travel service page transmission request received by the first request receiving portion 113, the first page transmitting portion 114 acquires the first travel service page specified by that first travel service page transmission request from the first page storing portion 111. It then transmits the acquired first travel service page. The first page transmitting portion 114 may be constituted by a wired or wireless communications means such as a modem or a network card, or a wired or wireless broadcasting means.

The second information storing portion 121 stores second travel service information, which is information relating to reservation for the second travel service. The second travel service information (hereinafter, referred to as “second information”) may be stored, for example, as several separate data items so that it can be retrieved using a retrieval key. The information relating to reservation for the second travel service may be, for example, information indicating the state of whether reservation for the second travel service is possible. In this first embodiment, an exemplary case is described in which the second travel service is a passenger transport service using airplanes. The second information is passenger transport reservation information relating to reservation of a passenger transport service using airplanes. The passenger transport reservation information may be information such as the seat availability, the fare and the like for airplanes. The second information storing portion 121 can be implemented, for example, with a nonvolatile recording medium or a volatile recording medium. Examples of the nonvolatile recording medium include a hard disk and a non-rewritable optical disk.

In this embodiment, although not shown, the second travel service server information 120 includes a second information acquisition portion by way of example. This acquisition portion receives a request from the outside to transmit the second information, acquires the second information specified by that transmission request from the second information storing portion 121, and transmits the acquired second information to a device that is the sender of the transmission request. Such an acquisition portion may be implemented, for example, with an MPU or a memory, and a wired or wireless communications means such as a modem or a network card, or a wired or wireless broadcasting means.

The arrangement page storing portion 131 stores a travel service arrangement page, which is a web page relating to arrangement for reservation for the above-described first and second travel services. The arrangement for reservation is a process performed in relation to reservation, and may be, for example, an inquiry about whether a reservation is possible, estimation of service fees, application of a reservation, or the like. Specifically, the travel service arrangement page is a page for receiving input of the user information necessary for making arrangements for the first and second travel services. The content that has been input on this page can be transmitted to the first information acquisition portion 134 and the second information acquisition portion 135, in response to a user instruction. This travel service arrangement page may be constituted by a single page, or may be constituted, for example, by a plurality of linked pages or a plurality of pages displayed in a plurality of frames on a single page. The arrangement page storing portion 131 may be constituted by an MPU or a memory, or a nonvolatile or volatile recording medium.

In response to a jump instruction from the information terminal 140, the arrangement page transmitting portion 132 transmits, to the information terminal 140, the travel service arrangement page, to which the first travel service page jumps. Specifically, it acquires the travel service arrangement page specified by the jump instruction from the arrangement page storing portion 131, and transmits this to the information terminal 140. “Jump” means to follow the link of a web page and output the link destination page, and specifically, it means to acquire the data of the link destination web page and to ouput it. “Jump instruction” refers to an instruction for performing such a jump. The arrangement page transmitting portion 132 may be constituted by a wired or wireless communications means such as a modem or a network card, or a wired or wireless broadcasting means. It may also include an MPU, a memory or the like.

Additionally, the travel service arrangement page acquired by the arrangement page transmitting portion 132 may be a web page whose content is dynamically rewritten or recombined in response to a jump instruction from the information terminal 140.

The user information receiving portion 133 receives, as the user information, traveler information, which is information relating to a traveler, and travel duration information, which is information relating to travel duration. There is no limitation with respect to the data structure of the traveler information and the travel duration information that are to be received. Traveler information refers to, for example, information such as the number of travelers, and the name, age, sex, address and contact number for all or some of the travelers. The traveler as mentioned herein refers to an individual or a group of people who travel. Travel duration information may be, for example, information such as a departure date, a return date, the length of stay, and a traveling date. The user information receiving portion 133 may be constituted by a wired or wireless communications means such as a modem or a network card, or a wired or wireless broadcasting means.

The first information acquisition portion 134 acquires the first information from the first information storing portion 112 of the first travel service server device 110 based on the traveler information and the travel duration information that have been received by the user information receiving portion 133. Specifically, the first information acquisition portion 134 converts the traveler information and the travel duration information, each of which is information on the user side, into information for the provider of the first travel service, and uses this information to acquire the first information. The conversion may be performed in any manner. In this embodiment, since the first travel service is described as a service providing accommodations by way of example, a case will be described in which the accommodation information is acquired as the first information based on the traveler information and the travel duration information. The first information acquisition portion 134 may be constituted, for example, by a wired or wireless communications means, or a wired or wireless broadcasting means. It may also include an MPU, a memory or the like.

The room type deciding means 1341 decides the room type of an accommodation based on the traveler information received by the user information receiving portion 133. “Room types” refer to categories into which the rooms that an accommodation has are divided based on several elements. The room type may be determined in any manner.

For example, the room type may be decided in accordance with the number of the travelers such that all of the travelers can stay at the same room. Or, the sex of the travelers may be determined, and if the travelers are a couple of a male and a female, then the room type may be decided to be a double bed room. Alternatively, the age of each traveler may be compared with a predetermined threshold value, for example, 18, and the traveler may be determined to be an adult if the age is equal to or higher than this threshold value, or determined to be a child if it is lower than the threshold value. If it is judged that a group of travelers is constituted by two adults and two children, then the room type may be decided to be a family room. That is, the room type deciding means 1341 converts the information on the traveler, who is the user, into the information on the side of the hotel, i.e., the room type information. The room type deciding means 1341 may be implemented, for example, with an MPU or a memory.

The accommodation information acquisition means 1342 acquires the first information, i.e., the accommodation information, from the first travel service server device 110, using the travel duration information received by the user information receiving portion 133 and the room type decided by the room type deciding means 1341 as keys. For example, it creates an acquisition request including these keys, and transmits this acquisition request to the first travel service server device 110. Then, it lets the first travel service server device 110 perform a search in the first information storing portion 112 based on these keys to acquire the first information that matches these keys. The accommodation information acquisition means 1342 may then acquire the first information by letting the first travel service server device 110 transmit the acquired first information to the accommodation information acquisition means 1342.

If the matching first information is not present in the first information storing portion 112, then information indicating that there is no matching information may be transmitted to the accommodation information acquisition means 1342 as the first information. Specifically, this first information acquisition request may be, for example, a search formula. The accommodation information acquisition means 1342 may be constituted, for example, by a wired or wireless communications means, or a wired or wireless broadcasting means. It may also include an MPU, a memory or the like.

The second information acquisition portion 135 acquires the second information from the second information storing portion 121 of the second travel service server device 120 based on the traveler information and the travel duration information that have been received by the user information receiving portion 133. Specifically, the second information acquisition portion 135 converts the traveler information and the travel duration information, each of which is information on the user side, into information on the side of the provider of the second travel service, and uses this information to acquire the second information. The conversion may be performed in any manner. In this embodiment, since the second travel service is described as a passenger transport service using an airplane by way of example, a case will be described in which the reservation information of the passenger transport using an airplane is acquired as the second information based on the traveler information and the travel duration information. The second information acquisition portion 135 may be constituted, for example, by a wired or wireless communications means, or a wired or wireless broadcasting means. The second information acquisition portion 135 may also include an MPU, a memory or the like.

The seat count deciding means 1351 decides the seat count based n age information indicating the age of the traveler that is included in he traveler information. The seat count may be decided in any manner. For example, no seat is required for a traveler under 3 years of age on domestic flights in Japan, and no seat is required for a traveler under 2 years of age on international flights. For this reason, in the case of using a domestic flight, it is judged whether each traveler is 3 years of age or older, and no seat will be provided for a traveler who is under 3 years of age. On the other hand, in the case of an international flight, no seat will be provided for a traveler under 2 years of age. The seat count for the travelers may be decided in this manner. That is, the seat count deciding means 1351 converts the information on the travelers, who are the user, into the information on the side of the provider of the passenger transport service, i.e., the seat count information. The seat count deciding means 1351 may be implemented with an MPU or a memory, or the like.

The date deciding means 1352 decides the date of use of the passenger transport service with an airplane, i.e., the boarding date, based on the travel duration information. The date of use may be decided in any manner. For example, when the travel duration information is information specifying the check-in date and check-out date at an accommodation in the travel destination, the departure date may be determined by calculation such that the traveler can arrive at the accommodation in the travel destination on that check-in date, and this may be decided to be the boarding date. Or, the check-out date from the accommodation in the travel destination may be decided to be the boarding date for return, i.e., the return date. When the t ravel duration information includes information indicating the date of use of the passenger transport service using an airplane or a date corresponding to this, that information itself may be set to the date of use. That is, the date deciding means 1352 converts the information on the side of the travelers, which are the user, into the information on the side of the provider of the passenger transport service, i.e., the information of the date of use of the passenger transport service. The date deciding means 1352 may be implemented with an MPU, a memory or the like.

The passenger transport reservation information acquisition means 1353 acquires the second information, i.e., the passenger transport reservation information, using the seat count decided by the seat count deciding means 1351 and the traveling date decided by the date deciding means 1352 as keys. For example, it creates an acquisition request including these keys, and transmits this acquisition request to the second travel service server device 120. Then, it lets the second travel service server device 120 perform a search in the second information storing portion 121 based on these keys to acquire the second information that matches these keys. Then, the passenger transport reservation information acquisition means 1353 may acquire the passenger transport reservation information by letting the second travel service server device 120 transmit the acquired second information to the passenger transport reservation information acquisition portion 1353. If the matching second information is not present, then information indicating that there is no matching information may be transmitted to the transport reservation information acquisition portion 1353 as the second information. Specifically, the second information acquisition request may be, for example, a search formula. The passenger transport reservation information acquisition means 1353 may be constituted, for example, by a wired or wireless communications means, or a wired or wireless broadcasting means. It may also include an MPU, a memory or the like.

The acquired information transmitting portion 136 acquires the first information acquired by the first information acquisition portion 134 and the second information acquired by the above-described second information acquisition portion 135, and transmits them. Here, as described above, the first information is accommodation information, and the second information is passenger transport reservation information. The acquired information transmitting portion 136 may be constituted, for example, by a wired or wireless communications means, or a wired or wireless broadcasting means.

The input receiving portion 144 receives input of the first travel service page transmission request, a jump instruction and user information including the traveler information and the above-described accommodation information. “Jump instruction” refers to information instructing a jump to the link destination specified by the link of the first travel service page, and includes, for example, information indicating the location where the link destination web page is present. The information indicating the location where the link destination web page is present may be anything, including, for example, the URL or URI of the link destination web page, a folder name with a file name, or an IP address with a file name. For example, the input receiving portion 144 may receive information that has been input from an input device such as a keyboard, a mouse, a touch panel or a ten-key pad, information that has been transmitted via a wired or wireless communications line, or information that has been read out from a recording medium such as an optical disk, a magnetic disk or a semiconductor memory. In this embodiment, the input of user information is performed using, for example, the travel service arrangement page. It should be noted that the input receiving portion 144 may or may not include a device for performing receiving, such as a modem or a network card. In addition, the input receiving portion 144 may be implemented with hardware such as a mouse, or may be implemented with software such as a driver for driving a predetermined device.

The information transmitting portion 141 transmits the first travel service page transmission requeskat received by the input receiving portion 144 to the first travel service server device 110. It also transmits the jump instruction received by the input receiving portion 144 to the travel service arrangement server device 130. Further, it transmits the user information received by the input receiving portion 144 to the travel service arrangement server device. The information transmitting portion 141 may be constituted by a wired or wireless communications means such as a modem or a network card, or a wired or wireless broadcasting means.

The information receiving portion 142 receives the first travel service page from the first travel service server device 110. It also receives the travel service arrangement page, the first information and the second information from the travel service arrangement server device 130. The information receiving portion 142 may be constituted, for example, by a wired or wireless communications means such as a modem or a network card, or a wired or wireless broadcasting means.

The information output portion 143 outputs the first travel service page, the travel service arrangement page, the first information and the second information that have been received by the information receiving portion 142. For example, it displays these pieces of information on a display, or prints them. The information output portion 143 may or may not include an output device for outputting them, such as a CRT, a liquid crystal display or a printer. The information output portion 143 may be implemented, for example, with driver software of an output device, or driver software of an output device and the output device.

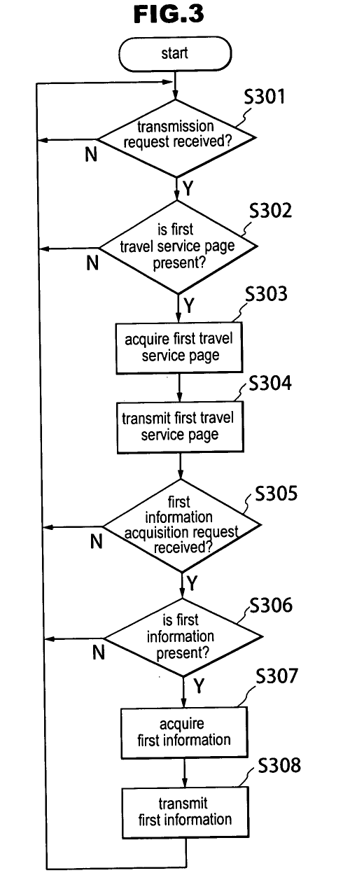

The operation of the first travel service server device 110 of the information processing system according to Embodiment 1 will be described with reference to the flowchart of FIG. 3.

(Step S301) The first request receiving portion 113 judges whether the first travel service page transmission request has been received. If it has been received, then the procedure advances to Step S302, and if it has not been received, then the procedure returns to Step S301.

(Step S302) The first page transmitting portion 114 judges whether the first travel service page specified by the first travel service page transmission request received by the first request receiving portion 113 is present in the first page storing portion 111. If it is present, then the procedure advances to Step S303, and if it is not present, then the procedure returns to Step S301.

(Step S303) The first page transmitting portion 114 acquires the first travel service page specified by the first travel service page transmission request from the first page storing portion 111.

(Step S304) The first page transmitting portion 114 transmits the acquired first travel service page to the output source device of the first travel service page transmission request.

(Step S305) The acquisition portion (not shown) of the first travel service server device 110 judges whether the first information acquisition request has been received. If it has been received, then the procedure advances to Step S306, and if it has not been received, then the procedure returns to Step S301.

(Step S306) The acquisition portion (not shown) of the first travel service server device 110 judges whether the first information that matches the keys included in the first information acquisition request is present in the first information storing portion 112. If it is present, then the procedure advances to Step S307, and if it is not present, then the procedure returns to Step S301.

(Step S307) The first information acquisition portion (not shown) of the first travel service server device 110 acquires the first information specified by the first information acquisition request from the first information storing portion 112.

(Step S308) The first information acquisition portion (not shown) of the first travel service server device 110 transmits the first information acquired from the first information storing portion 112 to the output source of the first information acquisition request. Thereafter, then the procedure returns to Step S301.

It should be noted that in the flowchart of FIG. 3 the process is terminated by turning the power off or by a processing-end interrupt.

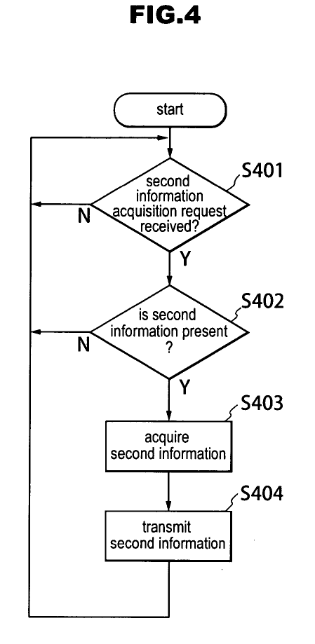

Next, the operation of the second travel service server device 120 of the information processing system according to Embodiment 1 will be described with reference to the flowchart of FIG. 4.

(Step S401) The acquisition portion (not shown) of the second travel service server device 120 judges whether the second information acquisition request has been received. If it has been received, then the procedure advances to Step S402, and if it has not been received, then the procedure returns to Step S401.

(Step S402) The second information acquisition portion (not shown) of the second travel service server device 120 judges whether the second information that matches the keys included in the second information acquisition request is present in the second information storing portion 121. If it is present, then the procedure advances to Step S403, and if it is not present, then the procedure returns to Step S401.

(Step S403) The acquisition portion (not shown) of the second travel service server device 120 acquires the second information specified by the second information acquisition request from the second information storing portion 121.

(Step S404) The acquisition portion (not shown) of the second travel service server device 120 transmits the second information acquired from the second information storing portion 121 to the output source of the second information acquisition request. Thereafter, then the procedure returns to Step S401.

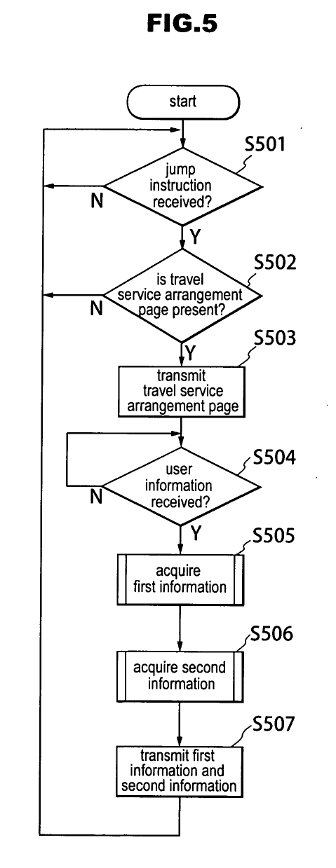

Next, the operation of the travel service arrangement server device 130 of the information processing system according to Embodiment 1 will be described with reference to the flowchart of FIG. 5.

(Step S501) The arrangement page transmitting portion 132 judges whether a jump instruction has been received. If it has been received, then the procedure advances to Step S502, and if it has not been received, then the procedure returns to Step S501.

(Step S502) The arrangement page transmitting portion 132 performs a search to determine whether the travel service arrangement page specified by the jump instruction is stored in the arrangement page storing portion 131. If it is stored, then the procedure advances to Step S503, and if it is not stored, then the procedure returns to Step S501.

(Step S503) The arrangement page transmitting portion 132 acquires the travel service arrangement page specified by the jump instruction from the arrangement page storing portion 131, and transmits it to the output source of the jump instruction.

(Step S504) The user information receiving portion 133 judges whether the user information, i.e., the traveler information and the travel duration information, has been received. If it has been received, then the procedure advances to Step S505, and if it has not been received, then the procedure returns to Step S504.

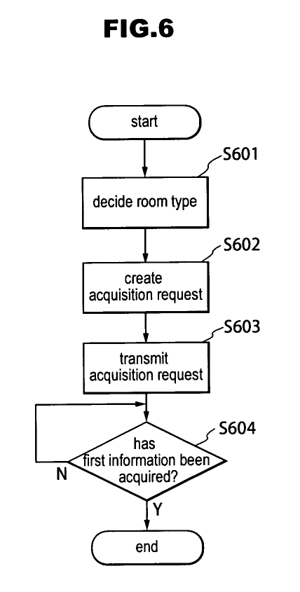

(Step S505) The first information acquisition portion 134 acquires the first information based on the user information received by the user information receiving portion 133. The details of this process of acquiring the first information will be described with reference to FIG. 6.

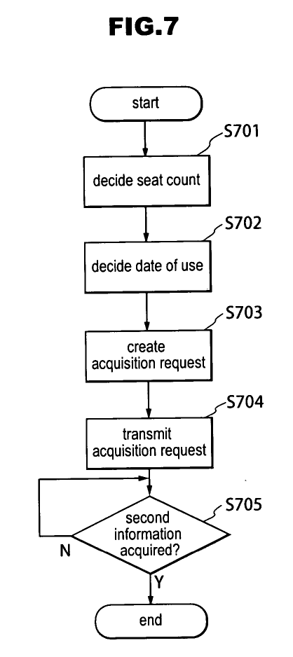

(Step S506) The second information acquisition portion 135 acquires the second information based on the user information received by the user information receiving portion 133. The details of this process of acquiring the second information will be described with reference to FIG. 7. It should be noted that in this embodiment the order of the process of Step S505 and the process of Step S506 may be switched.

(Step S507) The acquired information transmitting portion 136 transmits the first information acquired by the first information acquisition portion 134 and the second information acquired by the second information acquisition portion 135 to the input source of the user information. Thereafter, the procedure returns to Step S501.

It should be noted that in the flowchart of FIG. 5, the process is terminated by turning the power off of by a processing-end interrupt.

The process of acquiring the first information will be described with reference to the flowchart of FIG. 6.

(Step S601) The room type deciding means 1341 decides the room type based on the traveler information included in the user information received by the user information receiving portion 133. That is, the traveler information, which is information on the user side, is converted into the room type information, which is information on the side of the provider of the first travel service.

(Step S602) The accommodation information acquisition means 1342 creates a first information acquisition request that includes, as search keys, the travel duration information included in the user information received by the user information receiving portion 133, and the room type decided by the room type deciding means 1341.

(Step S603) The accommodation information acquisition means 1342 transmits the acquisition request to the first travel service server device 110.

(Step S604) The accommodation information acquisition means 1342 judges whether the first information has been acquired. If it has been acquired, then the process is terminated, and if it has not been acquired, then the procedure returns to Step S604.

The process of acquiring the second information will be described with reference to the flowchart of FIG. 7. (

Step S701) The seat count deciding means 1351 decides the seat count based on the traveler information included in the user information received by the user information receiving portion 133. That is, the traveler information, which is information on the user side, is converted in the seat count information, which is information on the side of the provider of the second travel service.

(Step S702) The date deciding means 1352 decides the departure date or the return date, or the departure date and the return date for the passenger transport service based on the travel duration information included in the user information received by the user information receiving portion 133. That is, the traveler information, which is information on information on the user side, is converted into the information of the date of use, which is information on the side of the provider of the second travel service. It should be noted that the order of the process of Step S702 and the process of Step S701 may be switched.

(Step S703) The passenger transport reservation information acquisition means 1342 creates a second information acquisition request that includes, as search keys, the seat count decided by the seat count deciding means 1351 and the date of use decided by the date deciding means 1352.

(Step S704) The passenger transport reservation information acquisition means 1342 transmits the second information acquisition request to the second travel service server device 120.

(Step S705) The passenger transport reservation information acquisition means 1342 judges whether the second information has been acquired. If it has been acquired, then the process is terminated, and if it has not been acquired, then the procedure returns to Step S705.

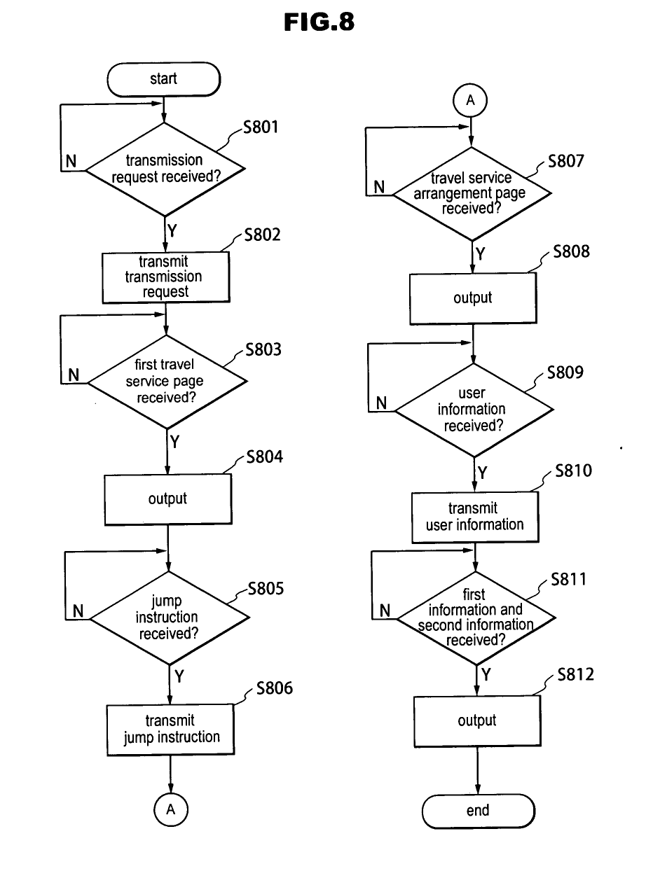

The operation of the information terminal 140 according to this embodiment will be described with reference to the flowchart of FIG. 8.

(Step S801) The input receiving portion 144 judges whether a transmission request for the first travel service page has been received. If it has been received, then the procedure advances to Step S802, and if it has not been received, then the procedure returns to Step S801.

(Step S802) The information transmitting portion 141 transmits the transmission request received by the input receiving portion 144.

(Step S803) The information receiving portion 142 judges whether the first travel service page has been received. If it has been received, then the procedure advances to Step S804, and if it has not been received, then the procedure returns to Step S803.

(Step S804) The information output portion 143 outputs the first travel service page received by the information receiving portion 142.

(Step S805) The input receiving portion 144 judges whether a jump instruction has been received. If it has been received, then the procedure advances to Step S806, and if it has not been received, then the procedure returns to Step S805.

(Step S806) The information transmitting portion 141 transmits the jump instruction received by the input receiving portion 144.

(Step S807) The information receiving portion 142 judges whether the travel service arrangement page has been received. If it has been received, then the procedure advances to Step S808, and if it has not been received, then the procedure returns to Step S807.

(Step S808) The information output portion 143 outputs the travel service arrangement page received by the information receiving portion 142.

(Step S809) The input receiving portion 144 judges whether input of user information including traveler information and travel duration information has been received. The input of the user information may be performed using, for example, the travel service arrangement page, which is displayed by the information output portion 143 on a CRT, a liquid crystal display or the like. If the input has been received, then the procedure advances to Step S810, and if it has not been received, then the procedure returns to Step S809.

(Step S810) The information transmitting portion 141 transmits the user information received by the input receiving portion 144 to the travel service arrangement server device 130.

(Step S811) The information receiving portion 142 judges whether the first information and the second information have been received. If they have been received, then the procedure advances to Step S812, and if they have not been received, then the procedure returns to Step S811.

(Step S812) The information output portion 143 outputs the first information and the second information that have been received by the information receiving portion 142.

Next, a specific example of the information processing system according to this embodiment will be described. Here, the network 150 is the Internet. The first travel service server device 110 is a server device that is used by ABCD Hotel located in Europe for operating its web site, and the second travel service server device 120 is a server device that is used by EFGH Airlines for operating its web site. Further, the first travel service page is the web page of the ABCD Hotel, and the second travel service page is the web page of the EFGH Airlines.

The user starts browser software on the information terminal 140, such as a PC, then inputs the URL of the web page of the ABCD Hotel to the browser using the keyboard, and clicks the button for moving to that web page. As a result, the input receiving portion 144 of the information terminal 140 receives a transmission request for the web page of the ABCD Hotel. This transmission request for the web page of the ABCD Hotel includes the URL of the web page of the ABCD Hotel. This transmission request for the web page of the ABCD Hotel is transmitted to the first travel service server device 110 from the information transmitting portion 141 based on the above-described URL.

The first request receiving portion 113 of the first travel service server device 110 receives the transmission request for the web page of the ABCD Hotel. The HTML file of the first travel service page is sorted in the directory in the first page storing portion 111 that is indicated by the URL included in the first travel service page transmission request. The first page transmitting portion 114 acquires the HTML file, and the image file and the like referred to by this file, and transmits these files to the information terminal 140 from the first page transmitting portion 114. The information receiving portion 142 of the information terminal 140 receives these HTML and image files, and the information output portion 143 displays the web page of the ABCD Hotel on a display based on these HTML and other files.

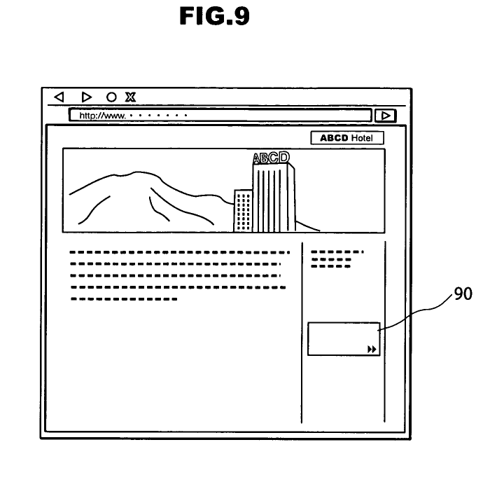

FIG. 9 shows an example of the displayed web page of the ABCD Hotel. On the right side of the first travel service page, a button 90 is provided that explains, for example, that arrangements for travel using the ABCD Hotel can be made. The button 90 is provided with a link to the HTML file of the travel service arrangement page for arranging reservation for travel using the ABCD Hotel. Travel using the ABCD Hotel refers to travel using the EFGH Airlines as the passenger transport service to the ABCD Hotel. The HTML file of the travel service arrangement page is stored in the arrangement page storing portion 131 of the travel service arrangement server device 130.

Let us assumed that the user looked at the web page of the ABCD Hotel, and clicked the button 90 using a mouse, with an intention to make travel using the ABCD Hotel. As a result, the input receiving portion 144 of the information terminal 140 receives a jump instruction to the link destination provided for the button 90, that is, a jump instruction to the URL provided for the button 90. The information transmitting portion 141 transmits this jump instruction to the travel service arrangement server device 130. The arrangement page transmitting portion 132 receives this jump instruction, then acquires the HTML file of the travel service arrangement page, and the image file and the like referred to by this file in accordance with the URL indicated by the jump instruction, and transmits these to the information terminal 140 from the arrangement page storing portion 131. When the information receiving portion 142 has received these HTML, image and other files, the information output portion 143 displays the travel service arrangement page on the display based on these HTML and other files.

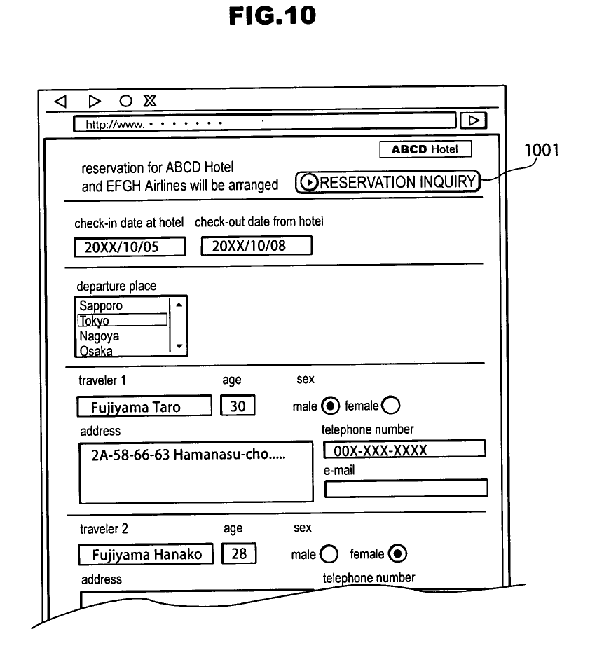

FIG. 10 shows an example of the displayed travel service arrangement page. As shown in the drawing, the travel service arrangement page is provided with a plurality of input fields for inputting user information. For example, these include an input filed for the check-in date at the hotel, an input field for the check-out date, an input field for the departure place, and input fields for the name, age, sex, address, telephone number, electronic mail address and the like for all the travelers. There is no limitation with respect to the input format of the input fields. For example, it is possible to employ fields in which characters are input, list that allow selection of contents to be input from among a plurality of choices, or buttons for selecting which contents are necessary and unnecessary to input. For example, in FIG. 10, the input field of the departure place is displayed in the form of a select list, and that of the sex is displayed in the form of buttons. In addition, a calendar or the like may be displayed, and a date selected from this calendar may be input as the departure date, the return date and the like. The contents input to these input fields serve as user information about the travelers, and in particular, the contents input to the input field of the check-in date at the hotel and the check-out date serve as travel duration information. Further, the contents input to the input fields for the name, age, sex, address, telephone number, electronic mail address and the like for all the travelers serve as traveler information.

Here, let us assume that the user intends to make travel staying at the ABCD Hotel from October 5 until October 8 in a group constituted by a 30 year old male, a 28 year old female, a 9 year old female and a 2 year old male, and presses a reservation inquiry button 1001 after inputting these pieces of information to the travel service arrangement page using a keyboard or the like. Upon this, the user information that has been input to the input fields of the travel service arrangement page are received by the input receiving portion 144, and this user information is transmitted to the travel service arrangement server device 130. This user information is received by the user information receiving portion 133 of the travel service arrangement server device 130. It should be noted that although the travel service arrangement page is constituted by a single page here, it may be constituted by a plurality of linked pages. In that case, the user information input to these pages may be transmitted to the travel service arrangement server device 130 for each of the pages.

The room type deciding means 1341 of the first information acquisition portion 134 decides the room type to be reserved by the travelers, based on the traveler information included in the information received by the user information receiving portion 133. Here, the travelers under 18 years of age are judged as children, and hence the travelers are determined to be constituted by two adults and two children. Accordingly, the room type is decided to be a family room. A family room of the ABCD Hotel is a room having one bed room with two semi double beds and two single beds. How the room to be reserved is decided is set in advance in the room type deciding means 1341.

Then, a first information acquisition request that includes, as search keys, this information specifying the room type decided by the room type deciding means 1341 and all of the information specifying the accommodation date that is obtained from the travel duration information included in the user information received by the user information receiving portion 133 is created by the accommodation information acquisition means 1342, and this is output to the first travel service server device 110.

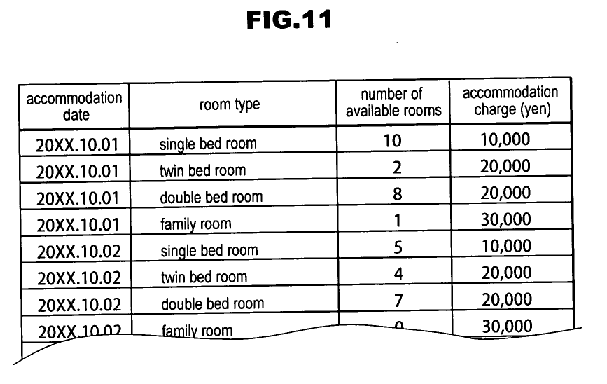

FIG. 11 is a diagram showing the data structure of the first information stored in the first information storing portion 112. The first information includes, for example, the accommodation date, the room type, the number of available rooms and the accommodation charge as data items. The accommodation date is a date of check-in at the hotel. The room type represents the type of rooms provided by the hotel. The ABCD Hotel provides four types of rooms, namely, a single bed room, a double bed room, a twin bed room and a family room. The number of available rooms is the number of rooms that have not been reserved, and is altered each time a reservation is made. The accommodation charge is an accommodation charge per room.

When the acquisition portion (not shown) of the first travel service server device 110 has received a first information acquisition request, this acquisition portion searches for the first information stored in the first information storing portion 112, using the search keys included in the first information acquisition request. Here, it searches for the first information that matches the accommodation date and the room type that are included in the first information acquisition request and that indicates that there is an available room. As a result of the search, if the first information that satisfies these conditions is present, then that first information is transmitted to the accommodation information acquisition portion 1342. If there is no information that satisfies the conditions, then information indicating that there is no information that satisfies the conditions is transmitted to the accommodation information acquisition portion 1342. Consequently, the accommodation information acquisition means 1342 acquires the first information.

The seat count deciding means 1351 of the second information acquisition portion 135 decides the seat count to be reserved by the travelers, based on the traveler information included in the user information received by the user information receiving portion 133. In the case of passenger transport services using airplanes in Japan, the minimum age for which a seat is required is different between domestic flights and international flights. No seat is required for a person under 3 years of age on domestic flights, whereas no seat is required for a person under 2 years of age on international flight. Therefore, for example, international flights will be used when the ABCD Hotel is located outside Japan, so that if the travelers include a two year old child, a seat will required for the child, and the seat for this child is counted when deciding the seat count for the travelers. On the other hand, domestic flights will be used when the ABCD Hotel is located in Japan, so that the seat for the 2 year old child is not counted when deciding the seat count for the travelers. Thus, the seat count for the travelers is decided. Here, since the ABCD Hotel is located outside Japan, the seat count for the travelers is decided to be 4. Additionally, whether a flight is domestic or international may be judged, for example, as follows. First, information of the country or region in which the first travel service is provided is included in the link of the first travel service page, and that information of the country or region is included in the jump instruction that the user obtains from this link. Then, when this jump instruction has been received, the second information acquisition portion 135 acquires the information on the country or region that is included in the jump instruction, and stores it in a memory or the like. Thereafter, when deciding the seat count, the seat count deciding means 1351 acquires that information on the country or region, then judges whether this information and the information on the departure place that is included in the user information are included in the same region, and judges the flight to be domestic if they are in the same region, and judges the flight to be international if they are in the different regions.

Alternatively, the country or region in which each of the first travel service server device 110 and the second travel service server device 120 is provided is determined from the domain of each of the server devices. Then, if it is judged that the first travel service server device 110 and the second travel service server device 120 are provided in the same country or region, then the flight is judged to be domestic since the airline and the hotel are located in the same region. If it is judged that they are not located in the same country or region, then the flight is determined to be international since the airline and the hotel are not located in the same region. Thus, it is possible to judge whether the flight is domestic or international. As a specific example, a character string representing the country or region in which the server is provided, such as JP or UK, is usually placed at the end of the domain. Accordingly, there are cases where the country or region in which a server device is provided can be determined from this character string in the domain. From this installation location of the server that can be obtained from the character string in the domain, the flight can be judged to be domestic, for example, when the server device of the hotel that provides the first travel service is located in Japan and the server device of the airline that provides the second travel service is also in Japan. When the server device of the hotel is located in France and the server device of the airline is located in Japan, the flight can be judged to be international.

The date deciding means 1351 of the first information acquisition portion 134 decides the boarding date for the EFGH Airlines based on the travel duration information included in the user information received by the user information receiving portion 133. Here, since the travel duration information in the user information is information indicating the check-in date and the check-out date at the hotel, the boarding date for departure is decided based on a traveling section such that the check-in date at the hotel is the date of arrival on the destination. Further, the boarding date for return is decided to be the check-out date from the hotel. Here, the traveling section is from Japan to Europe, and thus the air distance is long, so that the boarding date for departure is decided to be the day before the check-in date at the hotel, i.e., October 4. The boarding date for return is decided to be the check-out date from the hotel, i.e., October 8.

Then, a second information acquisition request that includes, as search keys, the seat count decided by the seat count deciding means 1351, the boarding dates decided by the date deciding means 1352 and the traveling section is created by the passenger transport reservation information acquisition means 1353, and this is output to the second travel service server device 120. The traveling section is the section between a departure place and a travel destination, and is determined by the passenger transport reservation information acquisition means 1353. The departure date is determined from the departure place information included in the user information that is selected by the user. The travel destination information can be acquired, for example, by including in advance the information on the airport nearest to the ABCD Hotel in the travel service arrangement page relating to the ABCD Hotel, and transmitting this information from the information terminal 140, together with the user information. Or, the first information acquisition portion 134 may store information relating to the ABCD Hotel, such as the information on the nearest airport, in a memory or the like in advance, and the information on the nearest airport or the like included in this information may be acquired when deciding the traveling section. In addition, since the EFGH Airlines is usually used for departure and return for travel, the second information acquisition request for departure and the second information acquisition request for return are each created and output.

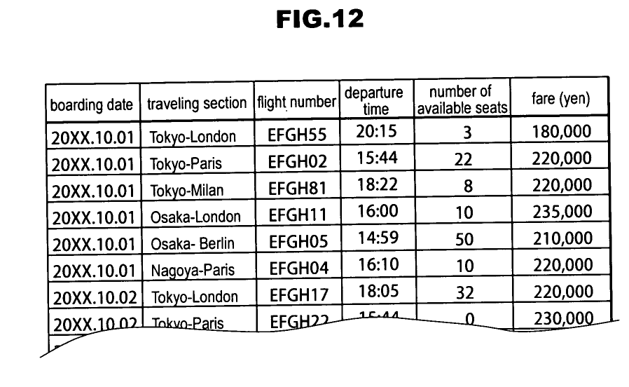

FIG. 12 is a diagram showing the data structure of the second information stored in the second information storing portion 112. second information includes the boarding date, the traveling section, the flight number, the departure time, the number of available seats, the fare and the like as data items,. The boarding date is the date on which a passenger flight departs, and is indicated by a date at a boarding place. The traveling section is indicated by a departure place and an arrival place. The flight number is a flight number of the EFGH Airlines. Each of the departure time and the arrival time is a local time. The number of available seats is the number of seats that have not been reserved, and is altered each time a reservation is made. The fare is indicated as an adult fare. Here, the child fare is an amount obtained by multiplying the adult fare by a predetermined ratio, for example, 70%.

When the acquisition portion (not shown) of the second travel service server device 120 has received the second information acquisition request, this acquisition portion searches for the second information stored in the second information storing portion 121, using the search keys included in the second information acquisition request. Here, it searches for the second information that matches the boarding date included in the second information acquisition request and the traveling section and that includes more available seats than the seat count included in the second information acquisition request. As a result of the search, it the second information that satisfies these conditions is present, then that second information is transmitted to the passenger transport reservation information acquisition means 1353. On the other hand, if there is no information that satisfies the conditions, then information indicating that there is no information that satisfies the conditions is transmitted to the passenger transport reservation information acquisition means 1353 as the second information. Consequently, the passenger transport reservation information acquisition means 1353 acquires the second information.

When the accommodation information acquisition portion 1342 has acquired the first information and the passenger transport reservation information acquisition portion 1353 has acquired the second information, the acquired information transmitting portion 136 transmits the acquired first information and second information to the information terminal 140.

The information receiving portion 142 receives the first information and second information. Then, the received first information and second information are displayed on the display by the information output portion 143.

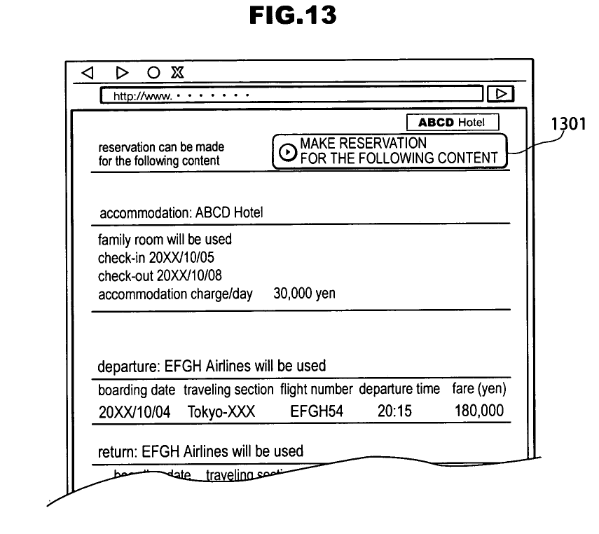

FIG. 13 is a diagram showing an example in which the first information and second information are displayed. As shown in the diagram, information is displayed that relates to the room that can be reserved at the ABCD Hotel and the flights of the EFGH Airlines that are to be used Accordingly, the user can know whether travel reservations can be made.

Additionally, in this embodiment, it is also possible to make reservations, in addition to inquiring whether reservations can be made. For example, a means for receiving reservations, such as a means for receiving the information necessary for making reservations and a means for storing the received information are provided in the first travel service server device 110 and the second travel service server device 120. Then, a button or the like for giving an instruction to make reservations, such as a button 1301, is provided on a page that displays results of inquiry as to whether reservations can be made, such as one shown in FIG. 13, and the above-described first information acquisition request and second information acquisition request, and other necessary traveler information are transmitted to the first travel service server device 110 and the second travel service server device 120 by pressing this button using a mouse. Then, the means for receiving reservations in the first travel service server device 110 and the second travel service server device 120 may make reservations using the received information and the like. When making reservations, newly required information, including, for example, a credit card number, may be additionally input by the user.

As described above, according to this embodiment, it is possible to arrange the reservation for the first travel service and the second travel service simply by entering information on the travel service arrangement page. This eliminates the need to separately arrange the reservation for the first travel service and that for the second travel service, thus reducing the complexity of the operation for arranging reservations, and improves the convenience for the user in making reservation inquiries.

Furthermore, the first information acquisition portion 134 and the second information acquisition portion 135 convert the user information into the information of the providers of the first and second travel services, and use this to acquire the reservation information. Accordingly, the user does not need to know the information on the side of the providers of the first and second travel services, such as what room types are available or from what age a seat is required. Even if the user does not know such information on the side of the providers of the first and second travel services, the user can acquire appropriate reservation information by converting the user information into the information on the side of the providers of the first and second travel services. Accordingly, the user can appropriately arrange reservation, so that it is possible to improve the convenience in arranging reservations. Furthermore, it is possible to reduce the items to be specified by the user when the user enters the user information, thus reducing the complexity of the operation for arranging reservations.

When arranging reservations using the travel service arrangement page, which is the link destination of the first travel service page, the reservation for the second travel service is arranged on the precondition that the first travel service is used, so that information determined by using the first travel service, such as information on the nearest airport to the destination, can be incorporated in the information necessary for making a reservation for the second travel service. Accordingly, it is not necessary for the user to input this information, thus reducing the complexity of the operation for making reservations and improving the convenience for the user in arranging reservations.

The user also arranges the reservation for the second travel service on the link destination from the first travel service page operated by the provider of the first travel service. Accordingly, it is possible to make the provider of the first travel service look like as if it performs, for example, arrangement for the reservation for the second travel service for the user as a part of its service. For such arrangement for the reservation for the second travel service, the provider of the first travel service does not need to actually arrange the reservation for the second travel service. Thus, it is possible for the provider of the first travel service to reduce the work and the personnel that have been needed to arrange the reservation for the second travel service. As a result, the provider of the first travel service can improve the quality of its service, while reducing the economic burden.

Although a case has been described in which the first travel service is a service providing hotels as accommodations in this embodiment, t he first travel service may be a service providing accommodations other than hotels.

Further, although a case has been described in which the second travel service is a service providing passenger transport using airplanes in this embodiment, the second travel service may be a service providing passenger transport using transporting means other than airplanes.

Additionally, in this embodiment, it is possible to provide, in the travel service arrangement server device 130, a configuration similar to that is employed in the second travel service server device 120, and to omit the second travel service server device 120. This also applies to other embodiments.

It is also possible to provide the first information storing portion 112, for example, in a server device other than the first travel service server device 110. This also applies to other embodiments.

In the respective embodiments, each structural component may be constituted by dedicated hardware. Or, a structural component that can be implemented with software may be implemented by executing a program. For example, each structural component can be implemented by reading out and executing a software program recorded in a recording medium such as a hard disk or a semiconductor memory by a program executing portion such as a CPU.

It should be noted that the software for implementing the first travel service server device of the information processing apparatus according to each of the embodiments is a program as follows. That is, this program is a program for letting a computer execute: a first request receiving step of receiving a page transmission request, which is a request to transmit a first travel service page including a link to a travel service arrangement page, which is a web page relating to a stored first travel service and relating to arrangement for reservation for a plurality of travel services including the first travel service; a first page transmitting step of transmitting the first travel service page if the page transmission request has been received; an acquisition request receiving step of receiving a request to acquire a first travel service information, which is information relating to reservation for the stored first travel service; and a first travel service information transmitting step of transmitting the first travel service information if the request to acquire the first travel service information has been received.

The software for implementing the travel service arrangement server device of the information processing apparatus according to each of the embodiments is a program as follows. That is, this program is a program for letting a computer execute: a user information receiving step of receiving traveler information, which is information relating to a traveler, and travel duration information, which is information relating to travel duration; a first information acquisition step of acquiring a first travel service information, which is information relating to reservation for a first travel service, based on the traveler information and the travel duration information; and a second information acquisition step of acquiring second travel service information, which is information relating to reservation for a second travel service, based on the traveler information and the travel duration information.

In the above-described program, the program further lets the computer execute an arrangement page transmitting step of transmitting a travel service arrangement page, which is a web page relating to arrangement for reservation for the first and second travel services, in response to a jump instruction based on a link to the travel service arrangement page that is included in a web page relating to the first travel service, and the traveler information and the travel duration information that have been received via the travel service arrangement page are received in the user information receiving step.

In the above-described program, the transmitting step of transmitting information, the receiving step of receiving information and the like do not include at least a process that is executed only with hardware, such as a process executed with a modem or an interface card in the transmitting step.

Further, this program may be executed by downloading it from a server or the like, or may be executed by reading out the program recorded in a predetermined recording medium, including, for example, an optical disk such as a CD-ROM, a magnetic disk and a semiconductor memory.

In addition, a single or a plurality of computers may execute this program. In other words, either centralized processing or distributed processing may be performed.

### Embodiment 2

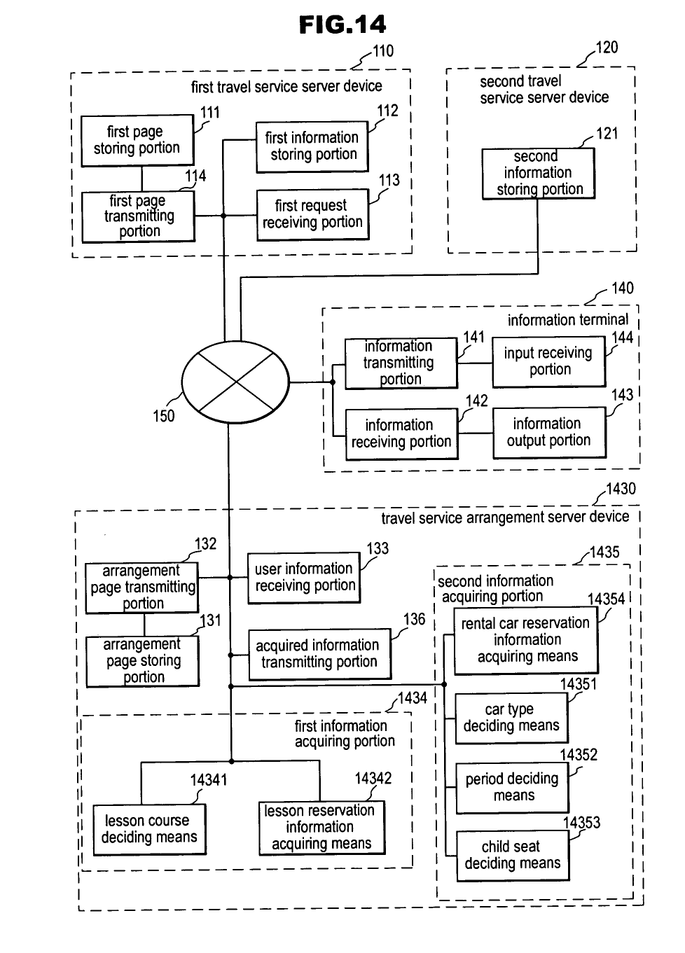

FIG. 14 is a block diagram showing the configuration of an information processing system according to Embodiment 2 of the present invention. The information processing system according to Embodiment 2 is provided with a first travel service server device 110, a second travel service server device 120, a travel service arrangement server device 1430 and an information terminal 140. The first travel service server device 110, the second travel service server device 120, the travel service arrangement server device 1430 and the information terminal 140 are connected to each other via a network 150. It should be noted that the configurations of the first travel service server device 110, the second travel service server device 120, the information terminal 140 and the network 150 are the same as those in Embodiment 1 described above, and therefore the description has been omitted. However, here, the first travel service is a service providing diving lessons, and the second travel service is a service providing rental cars in the region where the diving lessons are provided. The service providing diving lessons is one of services providing activities at a travel destination. Further, the first information stored in the first information storing portion 112 is lesson reservation information relating to the reservation for diving lessons. This lesson reservation information may be, for example, information such as the presence or absence of vacancy for diving lesson courses or the fee for lesson courses that can be reserved. Furthermore, the second information stored in the second information storing portion 121 is rental car reservation information relating to the reservation for rental cars. This rental car reservation information may be, for example, information such as the number of rental cars that have not been reserved or the fee for rental cars that can be reserved.

The travel service arrangement server device 1430 includes an arrangement page storing portion 131, an arrangement page transmitting portion 132, a user information receiving portion 133, a first information acquisition portion 1434, a second information acquisition portion 1435 and an acquired information transmitting portion 136. It should be noted that the configurations of the arrangement page storing portion 131, the arrangement page transmitting portion 132 and the acquired information transmitting portion 136 are the same as those in Embodiment 1 described above, and therefore the description has been omitted.

The first information acquisition portion 1434 includes a lesson course deciding means 14341 and a lesson reservation information acquisition means 14342.

The second information acquisition portion 1435 includes a car type deciding means 14351, a period deciding means 14352, a child seat deciding means 14353 and a rental car reservation information acquisition means 14354.

The first information acquisition portion 1434 acquires the first information from the first information storing portion 112 of the first travel service server device 110, based on the traveler information and the travel duration information that have been received by the user information receiving portion 133. Specifically, the first information acquisition portion 1434 converts the traveler information and the travel duration information, each of which is the information on the user side, into information on the side of the provider of the first travel service, and uses this information to acquire the first information. The conversion may be performed in any manner. The first information acquisition portion 134 may be constituted, for example, by a wired or wireless communications means, or a wired or wireless broadcasting means. It may also include an MPU or a memory or the like.

The lesson course deciding means 14341 decides the diving lesson course to be taken, based on the traveler information received by the user information receiving portion 133. The lesson course may be decided in any manner. For example, the age of each traveler may be compared with a predetermined threshold value, for example, 70, and if the age is equal to or higher than this threshold value, then a traveler may be determined to be a senior, and the diving lesson course may be decided to be a low difficulty level course intended for seniors.

Alternatively, the age of each traveler may be compared with a predetermined threshold value, for example, 18, and the traveler may be determined to be an adult if the age is equal to or higher than this threshold value, or is determined to be a child if the age is lower than the threshold value. If a group of travelers is constituted by adults and children, then the diving lesson course may be decided to be a family course for which an instructor exclusively for adults and an instructor exclusively for children are assigned. Also, the sex of each traveler may be determined, and if the traveler is a female or a group of females, then the diving lesson course may be decided to be a course intended for females for which a female instructor is assigned. That is, the lesson course deciding means 14341 converts the information on the side of the traveler, which is the user, into the information on the side of the diving school, i.e., the lesson course information. The lesson course deciding means 14341 may be implemented, for example, with an MPU or a memory or the like.

The lesson reservation information acquisition means 14342 acquires the first information, i.e., the lesson reservation information, from the first travel service server device 110, using the travel duration information received by the user information receiving portion 133 and the lesson course decided by the lesson course deciding means 14341 as keys. For example, it creates an acquisition request including these keys, and transmits this acquisition request to the first travel service server device 110. Then, it lets the first travel service server device 110 perform a search in the first information storing portion 112 based on these keys to acquire the first information that matches these keys. Then, the lesson reservation information acquisition means 14342 acquires the first information by letting the first travel service server device 110 transmit the acquired first information to the lesson reservation information acquisition means 14342. If the matching first information is not present, then information indicating that there is no matching information may be transmitted to the lesson reservation information acquisition means 14342 as the first information. The first information acquisition request may be, for example, a search formula. The lesson reservation information acquisition means 14342 may be constituted, for example, by a wired or wireless communications means, or a wired or wireless broadcasting means. It may also include an MPU or a memory or the like.

The second information acquisition portion 1435 acquires the second information, i.e., the rental car reservation information, from the second information storing portion 121 of the second travel service server device 120, based on the traveler information and the travel duration information that have been received by the user information receiving portion 133. Specifically, the second information acquisition portion 1435 converts the traveler information and the travel duration information, each of which is the information on the user side, into the information on the side of the provider of the second travel service, and uses this information to acquire the second information. The conversion may be performed in any manner. The second information acquisition portion 1435 may be constituted, for example, by a wired or wireless communications means, or a wired or wireless broadcasting means. The second information acquisition portion 1435 may also include an MPU or a memory or the like.

The car type deciding means 14351 decides the car type to be used, according to the number of the travelers included in the traveler information and their age composition. The car type may be decided in any manner. For example, if the travelers are constituted by a couple of a male and a female, then the car type may be decided to be a two-door sport car. For a group of travelers constituted by two adults and two children, the car type may be decided to be a family wagon car. That is, the car type deciding means 14351 converts the information on the side of the traveler, who is the user, into the information on the side of the rental car company, i.e., the car type information. The car type deciding means 14351 may be implemented with an MPU, a memory or the like.

The period deciding means 14352 decides the rental period of a rental car at the destination, based on the travel duration information. The rental period may be decided in any manner. For example, when the travel duration information is constituted by the arrival date at a travel destination and the departure date from the destination, the arrival date may be decided to be the rental start date, and the departure date may be decided to be the rental end date. On the other hand, when the travel duration information is constituted by the departure date from the departure place and information indicating the travel duration such as the length of stay at the destination, the rental period may be determined by calculation based on these pieces of information. That is, the period deciding means 14352 converts the information on the side of the traveler, who is the user, into the information on the side of the rental car company, i.e., the rental period information. The period deciding means 14352 may be implemented with an MPU, a memory or the like.

The child seat deciding means 14353 decides the necessity or not of reserving a child seat, according to the age of the traveler that is included in the traveler information. For example, it is judged whether the age of each of the travelers is under a predetermined age, and if there is any traveler who is under the predetermined age, then it is judged that a child seat is required for that traveler. As a specific example, if the travelers include a child under 6 years of age, it is decided that a child seat needs to be reserved. That is, the child seat deciding means 14353 converts the information on the side of the traveler, who is the user, into the information on the rental car company, i.e., the information on the necessity or not of a child seat. The child seat deciding means 14353 may be implemented with an MPU, a memory or the like.

The rental car reservation information acquisition means 14354 acquires the second information, i.e., in this case the rental car reservation information, using the car type decided by the car type deciding means 14351, the necessity or not of a child seat decided by the child seat deciding means 14353 and the rental period decided by the period deciding means 14352 as keys. For example, it creates an acquisition request including these keys, and transmits this acquisition request to the second travel service server device 120. Then, it lets the second travel service server device 120 perform a search in the second information storing portion 112 based on these keys to acquire the second information that matches these keys. The rental car reservation information acquisition means 14354 may then acquire the second information by letting the second travel service server device 120 transmit the acquired second information to the rental car reservation information acquisition means 14354. If the matching second information is not present, then information indicating that there is no matching information may be transmitted to the rental car reservation information acquisition portion 14354 as the second information. Specifically, this second information acquisition request may be, for example, a search formula. The rental car reservation information acquisition means 14354 may be constituted, for example, by a wired or wireless communications means, or a wired or wireless broadcasting means. It may also include an MPU, a memory or the like.

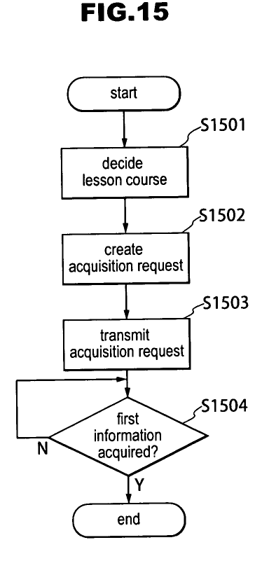

Next, the operation of acquiring the first information that is performed by the first information acquisition portion 1434 according to this embodiment will be described with reference to the flowchart shown in FIG. 15. It should be noted that this operation corresponds to the process of acquiring the first information in Step S505, which was described in Embodiment 1 above with reference to FIG. 5.

(Step S1501) The lesson course deciding means 14341 decides the lesson course based on the traveler information included in the user information received by the user information receiving portion 133. That is, the traveler information, which is the information on the user side, is converted into the lesson course information, which is the information on the side of the provider of the first travel service.

(Step S1502) The lesson reservation information acquisition means 14342 creates a first information acquisition request that includes, as search keys, the travel duration information included in the user information received by the user information receiving portion 1424 and the lesson course decided by the lesson course deciding means 14341.

(Step S1503) The lesson reservation information acquisition means 14342 transmits the acquisition request to the first travel service server device 110.

(Step S1504) The lesson reservation information acquisition means 14342 judges whether the first information has been acquired. If it has been acquired, then the process is terminated, and if it has not been acquired, then the procedure returns to Step S1504.

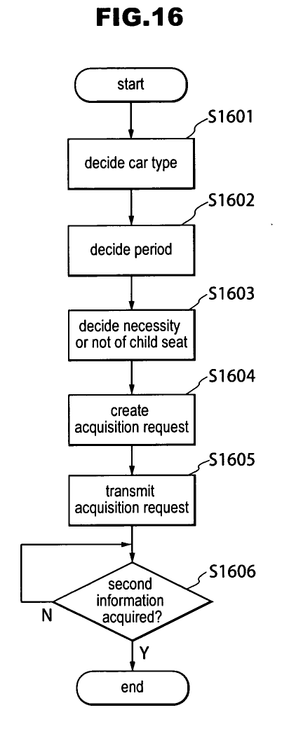

Next, the operation of acquiring the second information that is performed by the second information acquisition portion 1435 according to t his embodiment will be described with reference to the flowchart shown in FIG. 16. It should be noted that this operation corresponds to the operation of acquiring the second information in Step S506, which was described in Embodiment 1 above with reference to FIG. 5.

(Step S1601) The car type deciding means 14351 decides the car type of a rental car based on the traveler information included in the user information received by the user information receiving portion 133. That is, the traveler information, which is the information on the user side, is converted in to the car type information, which is the information on the side of the provider of the second travel service.

(Step S1602) The period deciding means 14352 decides the rental period of the rental car based on the travel duration information included in the user information received by the user information receiving portion 133. That is, the traveler information, which is the information on the user side, is converted in to the rental period information, which is the information on the side of the provider of the second travel service.

(Step S1603) The child seat deciding means 14353 determines the necessity or not of a child seat based on the traveler information included in the user information received by the user information receiving means 133. That is, the traveler information, which is the information on the user side, is converted into the information of the necessity or not of a child seat, which is the information on the side of the provider of the second travel service. It should be noted that there is no limitation with respect to the order in which the processes from Step S1601 through Step S1603 are performed.

(Step S1604) The rental car reservation information acquisition means 14354 creates a second information acquisition request that includes, as search keys, the car type decided by the car type deciding means 14351, the rental period decided by the period deciding means 14352, the necessity or not of a child seat decided by the child seat deciding means 14353.

(Step S1605) The rental car reservation information acquisition means 14354 transmits the second information acquisition request to the second travel service server device 120.

(Step S1606) The rental car reservation information acquisition means 14354 judges whether the second information has been acquired. If it has been acquired, then the process is terminated, and if it has not been acquired, then the procedure returns to Step S1606.

Next, a specific example will be described. It should be noted that the description of the components that are the same as those in the information processing system described in Embodiment 1 above has been omitted where appropriate. Here, the first travel service server device 110 is a server device used by IJKL Diving School for operating its web site, and the second travel service server device 120 is a server device used by MNOP Rent A Car for operating its web site. Further, the first travel service page is the web page of the IJKL Diving School, and the second travel service page is the web page of the MNOP Rent A Car.

The processes that are performed until the web page of the IJKL Diving School is displayed by the user are the same as the processes that are performed until the web page of the hotel is displayed in the specific example of Embodiment 1 described above, and therefore the description has been omitted here.

On the web page of the IJKL Diving School, there is provided a button indicating that it is possible to arrange reservations for taking diving lesson courses of the IJKL Diving School and that it is possible to arrange reservations for the rental cars of MNOP Rent A Car that are available in the region where the IJKL Diving School is located. When the user presses this button, for example, with an intention to make plans for travel for the purpose of taking a diving lesson course, the information terminal 140 outputs a jump instruction to a travel service arrangement page for arranging reservation for the diving lesson courses of the IJKL Diving School and reservation for rental cars of the MNOP Rent A Car, and the travel service arrangement page is displayed.

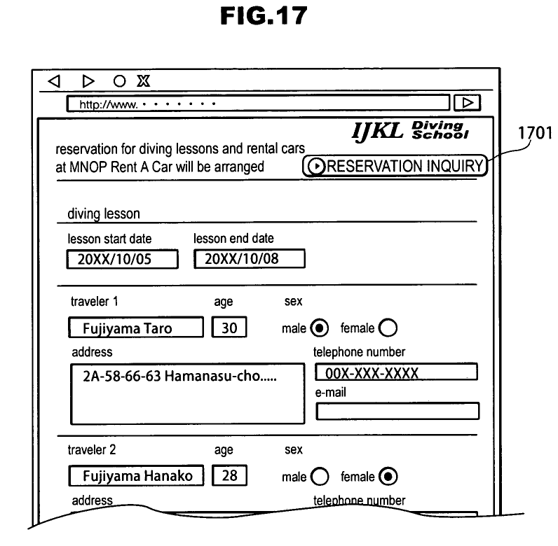

FIG. 17 shows an example of the displayed travel service arrangement page. As shown in the drawing, the travel service arrangement page is provided with a plurality of input fields for inputting user information. For example, these include input fields for the lesson start date and the lesson end date of a diving lesson course, and input fields for the name, age, sex, address, telephone number, electronic mail address and the like for all the travelers. The contents input to these input fields serve as user information about the travelers, and in particular, the contents input to the input fields of the lesson start date and the lesson end date of a diving lesson course serve as travel duration information. Further, the contents input to the input fields for the name, age, sex, address, telephone number, electronic mail address and the like for all the travelers serve as traveler information.

Here, the user intends to take a diving lesson from October 5 until October 8 in a group constituted by a 30 year old male, a 28 year old female, a 9 year old female and a 2 year old male, and presses a reservation inquiry button 1701 after inputting these pieces of information to the travel service arrangement page using a keyboard or the like. Upon this, the user information that has been input to the input fields of the travel service arrangement page are received by the input receiving portion 144. Then, the user information is transmitted to the travel service arrangement server device 130. This user information is received by the user information receiving portion 133 of the travel service arrangement server 130.

The lesson course deciding means 14341 of the first information acquisition portion 1434 decides the diving lesson course to be reserved by the travelers, based on the traveler information included in the user information received by the user information receiving portion 133. In this case, from the ages of all the travelers, it is judged that the travelers including the user are constituted by two adults and two children, and the diving lesson course is decided to be a family lesson course.

Then, a first information acquisition request that include, as search keys, the information specifying the decided lesson course and the information specifying the lesson start date and the lesson end date that is obtained from the travel duration information included in the user information received by the user information receiving portion 133 created by the lesson reservation information acquisition means 14342, and this is output to the first travel service server device 110.

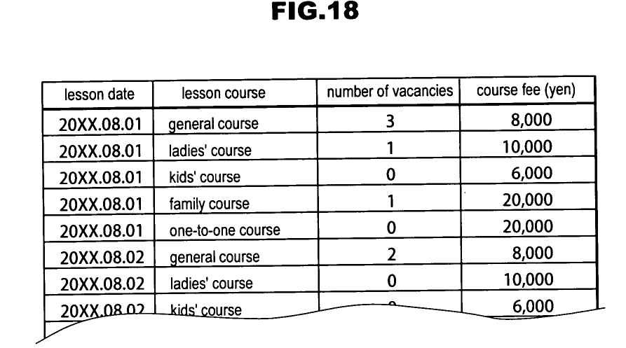

FIG. 18 is a diagram showing the data structure of the first information stored in the first information storing portion 112. The first information includes, as data items, the lesson date, the lesson course, the number of vacancies, the course fee and the like. The course attending date is a date on which a diving lesson is taken. The lesson course is the name of a diving lesson course provided by the IJKL Diving School. The number of vacancies is the number of persons who can take the lesson course, and is altered each time a reservation is made. The course fee is a course fee per day.

When a first information acquisition portion (not shown) of the first travel service server device 110 has received the first information acquisition request, this first information acquisition portion searches for the first information stored in the first information storing portion 112, using the search keys included in the first information acquisition request. Here, it searches for the first information that matches the lesson date and the lesson course that are included in the first information acquisition request and that indicates that there is a vacancy. As a result of the search, if the first information that satisfies the conditions is present, then that first information is transmitted to the lesson reservation information acquisition means 14342. If there is no information that satisfies the conditions, information indicating that there is no information that satisfies the conditions is transmitted to the lesson reservation information acquisition means 14342 as the first information. Consequently, the lesson reservation information acquisition means 14342 acquires the first information.

The car type deciding means 14351 of the second information acquisition portion 1435 decides the car type to be reserved by the travelers, based on the traveler information included in the user information received by the user information receiving portion 133. Here, since the travelers are constituted by two adults and two children, the car type is decided to be a family wagon car.

The period deciding means 14352 of the second information acquisition portion 1435 decides the rental period of a rental car of the MNOP Rent A Car, based on the travel duration information included in the user information received by the user information receiving portion 133. Here, since the lesson start date and the lesson end date of the diving lesson have been decided, the rental period of the rental car of the MNOP Rent A Car is decided to be a period from the day before the lesson start date, i.e., October 4 through the day after the lesson end date, i.e., October 9.

The child seat deciding means 14353 of the second information acquisition portion 1435 decides the necessity or not of a child seat, based on the traveler information included in the user information received by the user information receiving portion 133. Here, since the travelers include a 5 year old child, it is decided that a child seat is necessary.

Then, a second information acquisition request that includes, as search keys, the car type decided by the car type deciding means 14351, the rental period decided by the period deciding means 14352, the information indicating the necessity of a child seat that has been decided by the child seat deciding means 14353 and information of the delivery location of the rental car is created by the rental car reservation information acquisition means 14354, and this is output to the second travel service server device 120. It should be noted that the delivery location of the rental car can be acquired, for example, by embedding in advance information of the service office of the MNOP Rent A Car that is nearest to the IJKL Diving School, such as the name of the service office, in the travel service arrangement page relating to the IJKL Diving School, and transmitting this service office information from the information terminal 140, together with the user information. Alternatively, the first information acquisition portion 1434 may store in advance information relating to the IJKL Diving School, such as information of the nearest service office of the MNOP Rent A Car, in a memory or the like, and the information of the nearest service office of the MNOP Rent A Car company that is included in this information may be acquired when deciding the delivery location of the rental car. Here, the location is set to be the East Service Office of the MNOP Rent A Car, which is the nearest to the IJKL Diving School.

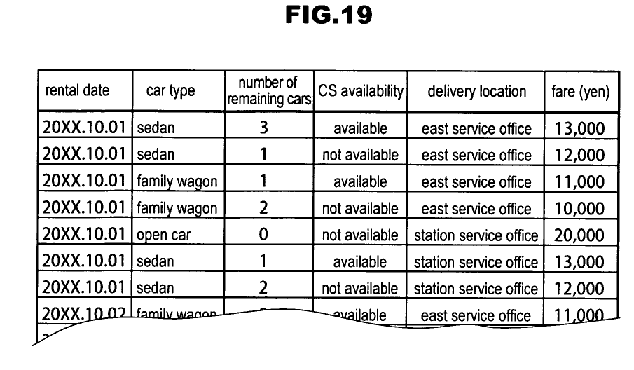

FIG. 19 is a diagram showing the data structure of the second information stored in the second information storing portion 112. The second information includes, as data items, the rental date, the car type, the number of remaining cars, the CS (child seat) availability, the delivery location, the use fee and the like. The rental date is a date on which a rental car is rented, and is shown in a local date. The car types re categories into which rental cars are classified according to their features. The number of remaining cars is the number of cars that have not been reserved, and is altered each time a reservation is made. The child seat availability indicates whether a child seat is provided. The delivery location is a location where the traveler picks up the rental car. The fee is a use date per day.

When the acquisition portion (not shown) of the second travel service server device 120 has received the second information acquisition request, this acquisition portion searches for the second information stored in the second information storing portion 121, using the search keys included in the acquisition request. Here, it searches for the second information that matches the rental date, the car type and the child seat availability included in the second information acquisition request, and that indicates that the number of remaining cars is not 0. As a result of the search, if the second information that satisfies these conditions is present, then that second information is transmitted to the rental car reservation information acquisition means 14354. On the other hand, if there is no information that satisfies the conditions, then information indicating that there is no information satisfying the conditions is transmitted to the rental car reservation information acquisition means 14354 as the second information. Consequently, the rental car reservation information acquisition means 14354 acquires the second information.

After the lesson reservation information acquisition portion 14342 has acquired the first information, and the rental car reservation information acquisition portion 14354 has acquired the second information, the same processes as those described in Embodiment 1 above are performed.

As described above, according to this embodiment, it is possible to make reservation inquiries for the first travel service and the second travel service by simply entering information on the travel service arrangement page. This eliminates the need to make reservation inquiries for the first travel service and the second travel service separately, thus making it possible to reduce the user work for making a reservation inquiry and to improve the convenience for the user in making a reservation inquiry.

Furthermore, the first information acquisition portion 1434 and the second information acquisition portion 1435 convert the user information into the information of the providers of the first and second travel services, and use this to acquire the reservation information. Therefore, the user does not need to know the information on the side of the providers of the first and second travel services, such as what kind of lesson courses are available, what types of rental cars are available, or from what age a child seat is required. Even if the user do not know such information on the side of the providers of the first and second travel services, it is possible to acquire appropriate reservation information by converting the user information into information on the side of the providers of the first and second travel services. Accordingly, the user can arrange suitable reservations, making it possible to improve the convenience in arranging reservation. Furthermore, it is possible to reduce the number of items to be specified by the user when entering user information, thus reducing the user's work for making reservation inquiries and improving the convenience for the in making reservation inquiries.

On the travel service arrangement page, which is the link destination of the first travel service page, the reservation inquiries for the first travel service and the second travel service are made on the precondition that the first travel service is used, so that information determined by using the first travel service, such as information of the delivery location of the rental car, can be incorporated in the information necessary for making a reservation for the second travel service. Accordingly, it is not necessary for the user to input this information, thus reducing the user's work for making reservation inquiries and improving the convenience for the user in making reservation inquiries.

The user also arranges the reservation for the second travel service on the link destination from the first travel service page operated by the provider of the first travel service. Accordingly, it is possible to make the provider of the first travel service look like as if it performs, for example, arrangement for the reservation for the second travel service for the user as a part of its service. For such arrangement for the reservation for the second travel service, the provider of the first travel service does not need to actually arrange the reservation for the second travel service. Thus, it is possible for the provider of the first travel service to reduce the work and the personnel that have been needed to arrange the reservation for the second travel service. As a result, the provider of the first travel service can improve the quality of its service, while reducing the economic burden.

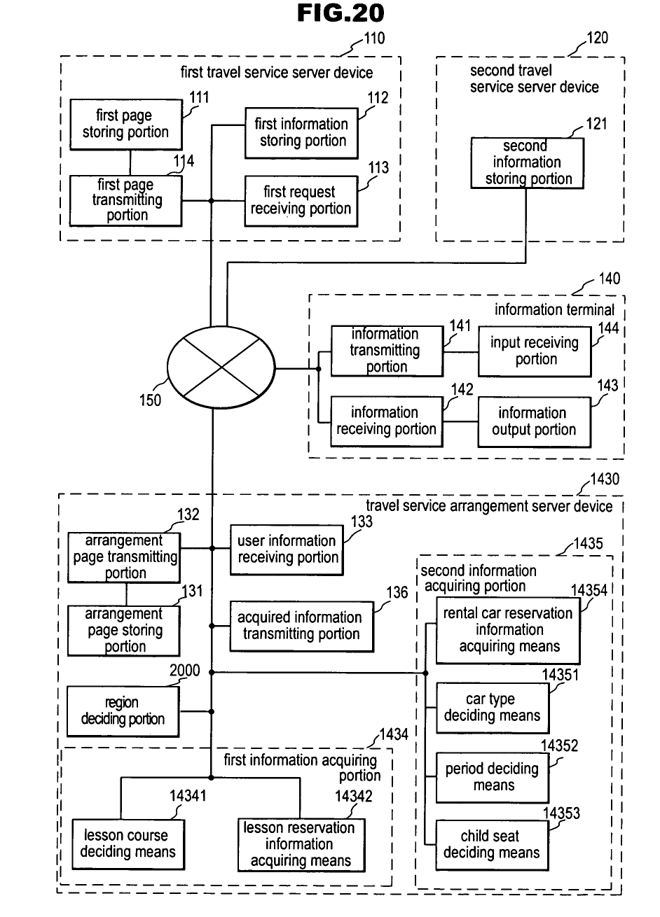

FIG. 20 is a diagram for illustrating a modified example of the information system according to this embodiment. In the drawing, the same reference numeral as in FIG. 14 denotes the same or corresponding part. In the following, a modified example of this embodiment will be described. First, information of the country or region in which the first travel service is provided is included in the information of the link of the first travel service page, and that information of the country or region is included in the jump instruction that the user obtains from this link. Further, as shown FIG. 20, a region deciding portion 2000 is provided that decides the travel destination country or region from the information of the country or region that is included in the jump instruction. Then, the settings on the first information acquisition portion 1434 and the second information acquisition portion 1435 for creating the first information acquisition request and the second information acquisition request are changed in accordance with the country or region in which the first travel service is provided, i.e., the travel destination country or region decided by the region deciding portion 2000.

For example, in this embodiment, the information of the necessity or not of a child seat that is decided by the child seat deciding means 14353 is used when making an inquiry as to whether a rental car can be reserved. However, the age for which a child seat is made compulsory may differ from one country to another. In such a case, it is possible to make an appropriate reservation for a rental car in a manner suitable for each country by correcting the age for which a child seat is required in accordance with the country information decided by the region deciding portion 2000, making it possible to prevent troubles that could occur in the travel destination. Accordingly, it is possible to save the troubles for the user to find local information when making a reservation inquiry. It should be noted that this also applies to Embodiment 1 above.

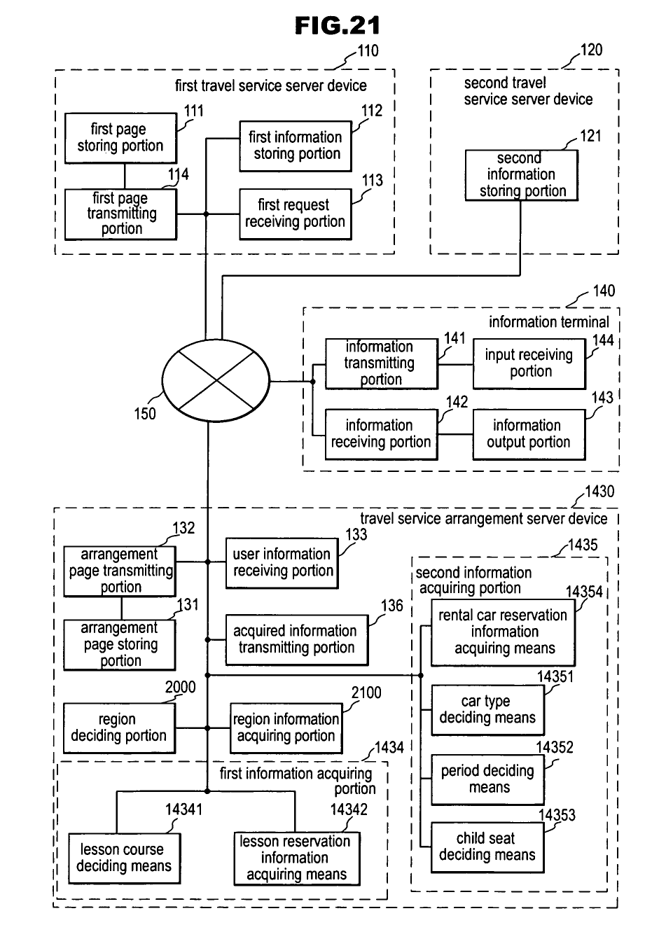

FIG. 21 is a diagram for illustrating another modified example of the information system according to this embodiment. In the drawing, the same reference numerals as in FIG. 20 denote the same or corresponding parts. In this modified example, a region information acquisition portion 2100 for acquiring local information in travel destinations is further provided in the modified example shown in FIG. 20, such that information specific to the region is acquired for a travel destination region decided by the region deciding portion 2000, and this is transmitted to the information terminal 120. Accordingly, the user can receive information about the travel destination that the user needs to know, such as things that need caution or things that are prohibited, making it possible to reduce the trouble for searching for the necessary information about the travel destination. This region-specific information can be acquired, for example, by preparing a dedicated data base in which region-specific information that is considered to be necessary for travel is collected, and performing a search on this data base using a region that will be the travel destination as a key. Provided that the travel destination is overseas, specific example of the region-specific information include information as to whether an international driver's license is required for driving a rental car, the presence or absence of restrictions on drinking, and the presence or absence of bans or penalties, for example, on smoking or luxury foods such as gums.

In this embodiment a case was described where the first travel service was a service providing diving lessons, but the first travel service according to the present invention may be a service providing other activities.

For example, the first travel service may be a service arranging reservation for tickets for sports events as activities. In this case, for example, a seat type deciding means or the like that decides the seat type according to the makeup of the travelers may be provided in place of the room type deciding means 1341. With this seat type deciding means, for example, it is possible to decide the seats to be reserved for a concert to be pair box seats for two persons when the travelers are constituted by one male and one female, or to be box seats for four person when the travelers constituted by four persons.

The first travel service may also be, for example, a service arranging reservation for eating places such as restaurants as activities. In this case, for example, a seat type deciding means that decides the seat count, the seat type and the like according to the makeup of the travelers may be provided in place of the room type deciding means 1341. With this seat type deciding means, for example, it is possible to provide a child chair when the travelers include a child. Or, if the restaurant does not admit children, then it is possible to inform the travelers to that effect and make a reservation for the number of seats excluding the seat for the child.

In Embodiments 1 and 2 described above, examples were described in which the first travel service was a service providing accommodations or a service providing activities, but the first travel service according to the present invention may be either a service providing accommodations, a passenger transport service, a service providing rental cars, a service providing activities, or the like.

In Embodiments 1 and 2 described above, examples were described in which the second travel service was a passenger transport service or a service providing rental cars, but the second travel service according to t he present invention may be either a service providing accommodations, a passenger transport service, a service providing rental cars, a service providing activities, or the like.

In Embodiments 1 and 2 described above, examples were described in which reservations for two travel services, namely, the first travel service and the second travel service were arranged, but the present invention can also be applied to a case where reservations for three or more travel services are arranged by additionally providing at least one travel service server device having the same configuration as that of the second travel service server device, and further providing an additional information acquisition portion similar to the first information acquisition portion or the second information acquisition portion in the same manner as with the additional travel service server device.

Additionally, in each of the above-described embodiments, each process or each functionality may be implemented by performing centralized processing with a single device or a single system, or may be implemented by performing distributed processing with a plurality of devices or a plurality of systems.

Furthermore, needless to say, the present invention is not limited to the above-described embodiments, and susceptible to various modifications, which also fall within the scope of the present invention.

### INDUSTRIAL APPLICABILITY

The information processing system according to the present invention can be used as a system or the like for arranging reservation for services relating to travel, and is particularly useful as a system or the like for arranging a plurality of services.

1. An information processing system comprising a first travel service server device, a second travel service server device, a travel service arrangement server device and an information terminal,
the first travel service server device comprising.
a first page storing portion that stores a first travel service page, which is a web page relating to the first travel service and including a link to a travel service arrangement page;
a first information storing portion that stores first travel service information, which is information relating to reservation for the first travel service;
a first request receiving portion that receives a first travel service page transmission request, which is a request to transmit the first travel service page, from the information terminal; and
a first page transmitting portion that transmits the first travel service page to the information terminal if the page transmission request has been received,
the second travel service server device comprising:
a second information storing portion that stores second travel service information, which is information relating to reservation for the second travel service,
the travel service arrangement server device comprising:
an arrangement page storing portion that stores the travel service arrangement page, which is a web page relating to arrangement for reservation for the first and second travel services;
an arrangement page transmitting portion that transmits, to the information terminal, the travel service arrangement page, to which the first travel service page jumps, in response to a jump instruction from the information terminal;
a user information receiving portion that receives traveler information, which is information relating to a traveler, and travel duration information, which is information relating to travel duration;
a first information acquisition portion that acquires the first travel service information in the first travel service server device based on the traveler information and the travel duration information;
a second information acquisition portion that acquires the second travel service information in the second travel service server device based on the traveler information and the travel duration information; and
an acquired information transmitting portion that transmits the first travel service information acquired by the first information acquisition portion and the second travel service information acquired by the second information acquisition portion,
the information terminal comprising:
an input receiving portion that receives input of the first travel service page transmission request, a jump instruction and user information including the traveler information and the travel duration information;
an information transmitting portion that transmits the first travel service page transmission request to the first travel service server device, transmits the jump instruction to the travel service arrangement server device, and transmits the user information to the travel service arrangement server device;
an information receiving portion that receives the first travel service page from the first travel service server device, and receives the travel service arrangement page, the first travel service information and the second travel service information from the travel service arrangement server device; and
an information output portion that outputs the first travel service page, the travel service arrangement page, the first travel service information and the second travel service information that have been received by the information receiving portion.

2. The information processing system according to claim 1,
wherein the first travel service is a service providing an accommodation,
wherein the first information storing portion of the first travel service server device stores accommodation information relating to reservation for the accommodation as the first travel service information, and
wherein the first information acquisition portion comprises:
a room type deciding means that decides a room type of the accommodation based on the traveler information; and
an accommodation information acquisition means that acquires the accommodation information from the first travel service server device, using the travel duration information and the room type as keys.

3. The information processing system according to claim 1,
wherein the second travel service is a service providing an accommodation,
wherein the second information storing portion of the second travel service server device stores accommodation information relating to reservation for the accommodation as the second travel service information, and
wherein the second information acquisition portion comprises:
a room type deciding means that decides a room type of the accommodation based on the traveler information; and
an accommodation information acquisition means that acquires the accommodation information from the second travel service server device, using the travel duration information and the room type as keys.

4. The information processing system according to claim 1,
wherein the first travel service is a passenger transport service,
wherein the first information storing portion of the first travel service server device stores, as the first travel service information, passenger transport reservation information relating to reservation for the passenger transport service, and
wherein the first information acquisition portion comprises:
a seat count deciding means that decides a seat count based on age information indicating the age of the traveler that is included in the traveler information;
a date deciding means that decides a departure date and/or return date from the travel duration information; and
a passenger transport reservation information acquisition means that acquires the passenger transport reservation information from the first travel service server device, using the seat count, and the departure date and/or return date as keys.

5. The information processing system according to claim 1,
wherein the second travel service is a passenger transport service,
wherein the second information storing portion of the second travel service server device stores, as the second travel service information, passenger transport reservation information relating to reservation for the passenger transport service, and
wherein the second information acquisition portion comprises:
a seat count deciding means that decides a seat count based on age information indicating the age of the traveler that is included in the traveler information;
a date deciding means that decides a departure date and/or return date from the travel duration information; and
a passenger transport reservation information acquisition means that acquires the passenger transport reservation information from the second travel service server device, using the seat count, and the departure date and/or return date as keys.

6. The information processing system according to claim 1,
wherein the first travel service is a service providing a rental car,
wherein the first information storing portion of the first travel service server device stores rental car information relating to reservation for the rental car as the first travel service information, and
wherein the first information acquisition portion comprises:
a car type deciding means that decides a car type to be reserved, based on the traveler information;
a period deciding means that decides a period for which the rental car is to be rented, based on the travel duration information; and
a rental car reservation information acquisition means that acquires the rental car information from the first travel service server device, using the car type and the period for which the rental car is to be rented as keys.

7. The information processing system according to claim 1,
wherein the second travel service is a service providing a rental car,
wherein the second information storing portion of the second travel service server device stores rental car information relating to reservation for the rental car as the second travel service information, and
wherein the second information acquisition portion comprises:
a car type deciding means that decides a car type to be reserved, based on the traveler information;
a period deciding means that decides a period for which the rental car is to be rented, based on the travel duration information; and
a rental car reservation information acquisition means that acquires the rental car information from the second travel service server device, using the car type and the period for which the rental car is to be rented as keys.

8. The information processing system according to claim 6 or 7,
wherein the traveler information includes age information relating to the age of the traveler, and
wherein the second information acquisition portion comprises
a child seat deciding means that decides the necessity or not of reserving a child seat, based on the age information.

9. The information processing system according to claim 1,
wherein the first travel service is a service providing an activity,
wherein the first information storing portion of the first travel service server device stores activity reservation information relating to reservation for the activity as the first travel service information, and
wherein the first information acquisition portion acquires the activity reservation information from the first travel service server device, based on the traveler information and the travel duration information.

10. The information processing system according to claim 1,
wherein the second travel service is a service providing an activity,
wherein the second information storing portion of the second travel service server device stores activity reservation information relating to reservation for the activity as the second travel service information, and
wherein the second information acquisition portion acquires the activity reservation information from the second travel service server device, based on the traveler information and the travel duration information.

11. The information processing system according to claim 1,
wherein the information acquired by the first information acquisition portion or the second information acquisition portion varies depending on the information in the first travel service server device that is included in the jump instruction from the information terminal.

12. The information processing system according to claim 1, further comprising:
a region deciding portion that decides a travel destination region based on the information in the first travel service server device that is included in the jump instruction from the information terminal,
wherein the information acquired by the first information acquisition portion or the second information acquisition portion varies depending on the region.

13. The information processing system according to claim 1,
wherein it is judged whether a region relating to the first travel service server device and a region relating to the second travel service server device are the same region, and the information acquired by the first information acquisition portion or the second information acquisition portion differs between when the regions are the same and when the regions are not the same.

14. The information processing system according to claim 12, further comprising:
a region information acquisition portion that acquires, based on the region, information unique to the region,
wherein the acquired information transmitting portion also transmits the information unique to the region.

15. A first travel service server device constituting the information processing system according to claim 1.

16. A second travel service server device constituting the information processing system according to claim 1.

17. A travel service arrangement server device constituting the information processing system according to claim 1.

18. An information terminal constituting the information processing system according to claim 1.

19. A travel service arrangement server device comprising:
a user information receiving portion that receives traveler information, which is information relating to a traveler, and travel duration information, which is information relating to travel duration;
a first information acquisition portion that acquires first travel service information, which is information relating to reservation for a first travel service, based on the traveler information and the travel duration information;
a second information acquisition portion that acquires second travel service information, which is information relating to reservation for a second travel service, base on the traveler information and the travel duration information; and
an acquired information transmitting portion that transmits the first travel service information acquired by the first information acquisition portion and second travel service information acquired by the second information acquisition portion.

20. An information processing system comprising:
a first request receiving step of receiving a page transmission request, which is a request to transmit a first travel service page, which is a web page relating to a stored first travel service and including a link to a travel service arrangement page, which is a web page relating to arrangement for reservation for a plurality of travel services including the first travel service;
a first page transmitting step of transmitting the first travel service page if the page transmission request has been received, an acquisition request receiving step of receiving a request to acquire a first travel service information, which is information relating to reservation for the stored first travel service; and
a first travel service information transmitting step of transmitting the first travel service information if the request to transmit the first travel service information has been received.

21. An information processing method comprising:
a user information receiving step of receiving traveler information, which is information relating to a traveler, and travel duration information, which is information relating to travel duration;
a first information acquisition step of acquiring first travel service information, which is information relating to reservation for a first travel service, based on the traveler information and the travel duration information;
a second information acquisition step of acquiring second travel service information, which is information relating to reservation for a second travel service, based on the traveler information and the travel duration information; and
a step of outputting the first travel service information and the second travel service information.

22. The information processing method according to claim 21, comprising:
an arrangement page transmitting step of transmitting a travel service arrangement page, which is a web page relating to arrangement for reservation for the first and second travel services, in response to a jump request based on a link to the travel service arrangement page that is included in a web page relating to the first travel service,
wherein the traveler information and the travel duration information that have been received via the travel service arrangement page are received in the user information receiving step.

23. A program for letting a computer execute:
a first request receiving step of receiving a page transmission request, which is a request to transmit a first travel service page including a link to a travel service arrangement page, which is a web page relating to a stored first travel service and relating to arrangement for reservation for a plurality of travel services including the first travel service;
a first page transmitting step of transmitting the first travel service page if the page transmission request has been received;
an acquisition request receiving step of receiving a request to acquire a first travel service information, which is information relating to reservation for the stored first travel service; and
a first travel service information transmitting step of transmitting the first travel service information if the request to acquire the first travel service information has been received.

24. A program for letting a computer execute:
a user information receiving step of receiving traveler information, which is information relating to a traveler, and travel duration information, which is information relating to travel duration;
a first information acquisition step of acquiring a first travel service information, which is information relating to reservation for a first travel service, based on the traveler information and the travel duration information; and
a second information acquisition step of acquiring second travel service information, which is information relating to reservation for a second travel service, based on the traveler information and the travel duration information.

25. The program according to claim 24,
wherein the program further lets the computer execute
an arrangement page transmitting step of transmitting a travel service arrangement page, which is a web page relating to arrangement for reservation for the first and second travel services, in response to a jump instruction based on a link to the travel service arrangement page that is included in a web page relating to the first travel service, and
wherein the traveler information and the travel duration information that have been received via the travel service arrangement page are received in the user information receiving step.
